(19) United States
(12) Patent Application Publication
(10) Pub. No.: US 2026/0026999 A1
(43) Pub. Date: Jan. 29, 2026

(54) SEXUAL MASSAGE DEVICE

(71) Applicant: Dongguan Mimao Electronic Technology Co., Ltd., Dongguan (CN)

(72) Inventors: Qinling WANG, Heyuan (CN); Yanna CHEN, Dongguan (CN)

(21) Appl. No.: 19/344,550

(22) Filed: Sep. 30, 2025

Related U.S. Application Data
(63) Continuation-in-part of application No. PCT/CN2024/134000, filed on Nov. 22, 2024.
(63) Continuation-in-part of application No. 18/746,012, filed on Jun. 17, 2024, now Pat. No. 12,458,562.
(63) Continuation-in-part of application No. 18/940,784, filed on Nov. 7, 2024.
(63) Continuation-in-part of application No. 18/945,496, filed on Nov. 12, 2024.
(63) Continuation-in-part of application No. 18/940,778, filed on Nov. 7, 2024, now Pat. No. 12,433,818.

(30) Foreign Application Priority Data
Sep. 30, 2024 (CN) 202422414425.9
Oct. 11, 2024 (CN) 202422463128.3

(51) Int. Cl. A61H 19/00; A61H 7/00; A61H 23/02

(52) U.S. Cl. CPC A61H 19/32; A61H 7/001; A61H 7/008; A61H 23/0254; A61H 2201/1215; A61H 2201/123; A61H 2201/1238; A61H 2201/1664; A61H 2201/1666; A61H 2201/1669; A61H 2201/1676

(57) ABSTRACT

The present disclosure provides a sexual massage device capable of massaging a penis. The sexual massage device includes: a massage body having a cavity to accommodate the penis; a clamping component installed in the massage body and configured to repeatedly clamp and release the penis thus performing a pinching massage on the penis; an installation portion mounted on the massage body; and a negative pressure generating component received in the installation portion. The massage body is able to be in a negative pressure state to apply pressure massage on the penis to massage the penis; the clamping component defines a receiving space to receive the penis.

### CROSS-REFERENCE TO RELATED APPLICATIONS

This is a continuation-in-part of PCT Patent Application No. PCT/CN2024/134000, filed on Nov. 22, 2024, which claims priorities of Chinese Patent Application No. 202422414425.9, filed on Sep. 30, 2024, and Chinese Patent Application No. 202422463128.3, filed on Oct. 11, 2024, the entire contents of which are hereby incorporated by reference.

### TECHNICAL FIELD

The present application relates to a sexual massage device, and in particular to a multi-functional sexual massage device.

### BACKGROUND

In recent years, sexual massage devices are developed to help the users to release their sex pressure. However, a traditional sexual massage device has limitations in structural design, thus the sexual massage device having poor adaptability and being unable to satisfy user demand. Generally, a traditional sexual massage device mostly only has vibrational massage function. Due to the presence of only one massage mode, their functionality is limited. Therefore, a traditional sexual massage device has unsatisfactory stimulation effect.

### SUMMARY

An object of the present application is to provide a multi-functional sexual massage device which can provide better stimulation effects, thereby improving massaging experience.

In order to achieve the above object, the present application provides a sexual massage device capable of massaging a penis. The sexual massage device includes:
a massage body having a cavity to accommodate the penis;
a clamping component installed in the massage body and configured to repeatedly clamp and release the penis to clamp the penis thus performing a pinching massage on the penis;
an installation portion mounted on the massage body; and
a negative pressure generating component received in the installation portion;
wherein the massage body is able to be in a negative pressure state provided by the negative pressure generating component to apply pressure massage on the penis to massage the penis; the clamping component defines a receiving space to receive the penis.

The present applicant further provides another sexual massage device capable of massaging a penis, the sexual massage device comprising:
a massage body having a cavity to accommodate the penis; and
a clamping component installed in the massage body and capable of repeatedly clamping and releasing the penis, the clamping component comprises at least two swing rods, the at least two swing rods are partially located inside the massage body or adjacent to an opening of the massage body, and the at least two swing rods are movable closer or apart from each other to stimulate the penis accommodated inside the cavity during use; or the clamping component comprises at least two sliders moving towards each other, the two sliders are located on two opposite sides of the cavity, and are movable closer or apart from each other to stimulate the penis accommodated inside the cavity during use;
wherein the massage body is able to be in a negative pressure state to apply pressure massage on the penis, and the clamping component is able to perform a pinching massage on the penis.

Compared with the prior art, the sexual massage devices provided by the present application apply pressure to sides of the target part such as a penis via the negative pressure generating component, at the same time the at least two swing rods of the clamping components repeatedly and alternately perform clamping and releasing action, thus achieving both pressure massage and pinching massage. Therefore, the sexual massage devices provide multi-functions and a good user experience.

### BRIEF DESCRIPTION OF THE DRAWINGS

In order to illustrate the technical solution in embodiments of the present application more clearly, the following briefly introduces accompanying drawings used in the description of the embodiments. Obviously, the accompanying drawings in the following description are only some embodiments of the present application. Those of ordinary skill in the art can obtain other accompanying drawings from these accompanying drawings without any creative efforts.

FIG. 1 is a perspective view of a sexual massage device according to a first embodiment of the present application.

FIG. 2 is a perspective view of the sexual massage device of FIG. 1 from another aspect.

FIG. 3 is a cross sectional view of the sexual massage device taken along line III-III of FIG. 1.

FIG. 4 is a schematic view of an assembly relationship of a clamping component and a housing of the sexual massage device of the present application.

FIG. 5 is a cross sectional view of the sexual massage device taken along a width direction of the sexual massage device of FIG. 1.

FIG. 6 is a schematic, isometric view of main components of the sexual massage device of the present application.

FIG. 7 is a perspective view of a sexual massage device according to a second embodiment of the present application.

FIG. 8 is a schematic view of inner components of the sexual massage device of FIG. 7 with removing part of the housing.

FIG. 9 is a cross sectional view of the sexual massage device taken along line IX-IX of FIG. 7.

FIG. 10 is a schematic view showing yet another application of the sexual massage device of the present application.

FIG. 11 is a perspective view of a sexual massage device according to a third embodiment of the present application.

FIG. 12 is a schematic view of main components of the sexual massage device according to the third embodiment of the present application with removing part of the housing.

FIG. 13 is a perspective view of a sexual massage device according to a fourth embodiment of the present application.

FIG. 14 is a schematic, exploded view of the sexual massage device of the fourth embodiment of the present application.

FIG. 15 is a schematic, exploded view of main components of the sexual massage device according to the fourth embodiment of the present application.

FIG. 16 is a cross sectional view of the sexual massage device of FIG. 12.

FIG. 17 is a perspective view of a sexual massage device according to a fifth embodiment of the present application.

FIG. 18 is a cross sectional view of the sexual massage device taken along one direction of FIG. 17.

FIG. 19 is a cross sectional view of the sexual massage device taken along another direction of FIG. 17.

FIG. 20 is a schematic, exploded view of the sexual massage device of FIG. 17.

FIG. 21 is a schematic view of main components of the sexual massage device of FIG. 17.

FIG. 22 is a perspective view of a sexual massage device according to a sixth embodiment of the present application.

FIG. 23 is a top plan view of the sex toy of FIG. 22.

FIG. 24 is a cross sectional view of the sex toy taken along line XXVI-XXVI of FIG. 23.

FIG. 25 is a cross sectional view of the sex toy taken along line XXVII-XXVII of FIG. 23.

FIG. 26 is a cross sectional view of the sex toy taken along line XXVIII-XXVIII of FIG. 23.

FIG. 27 is an exploded view of the sex toy of FIG. 22.

FIG. 28 is a further exploded view of the sex toy of FIG. 22, wherein an outer shell and an upper portion of an inner shell are removed.

FIG. 29a is an exploded view of a first stimulation module of the sex toy of FIG. 22.

FIG. 29b is an exploded view of the first stimulation module from another aspect.

FIG. 30a is a schematic view of an alternative embodiment of a swinging unit of the first stimulation module.

FIG. 30b is a schematic view of a third embodiment of the swinging unit.

FIG. 30c is a schematic view of a fourth embodiment of the swinging unit.

FIG. 30d is a schematic view of a fifth embodiment of the swinging unit.

FIG. 31 is a perspective view of a sexual massage device according to a seventh embodiment of the present application.

FIG. 32 is a schematic view of FIG. 31, viewed from another aspect.

FIG. 33 is a cross sectional view of the sex toy of FIG. 32, taken along line C-C.

FIG. 34 is a schematic view of the sex toy of FIG. 33 viewed from another aspect, wherein an inner tube is removed for clarity.

FIG. 35 is an exploded view of the sex toy of FIG. 31.

FIG. 36 is a further exploded view of the sex toy of FIG. 35, wherein main structures of the inner tube, a first stimulation module, and a massage portion are shown schematically.

FIG. 37 is a cross sectional view of a sexual massage device according to an eighth embodiment of the present application.

FIG. 38 is a partial perspective view of the sexual massage device of FIG. 37.

FIG. 39 is a perspective view of a massage body of the sexual massage device of FIG. 38.

FIG. 40 is a perspective view of the sexual massage device of FIG. 38 with removing the massage body and receiving cavity.

FIG. 41 is a cross sectional perspective view of FIG. 40.

FIG. 42 is a cross sectional perspective view of FIG. 40 viewed from another aspect.

### DESCRIPTION OF THE EMBODIMENTS

In order to make those skilled in the art better understand the technical solution of the present application, the technical solution in the embodiments of the present application will be clearly and completely described below with reference to accompanying drawings in the embodiments of the present application. Obviously, the described embodiments are only a part of the embodiments of the present application, but not all of the embodiments. Based on the embodiments of the present application, all other embodiments obtained by those skilled in the art without any creative efforts fall within the protection scope of the present application.

It should be noted that when an element is said to be “connected” to another element, it may be directly connected to another element, or indirectly connected to another element through one or multiple intermediate elements.

In the specification, the oriental or positional relationships indicated by the terms “longitudinal”, “transverse”, “top”, “bottom”, “inner”, “outer”, “central”, “axial”, “radial”, “circumferential” and the like are only intended to facilitate the description of the present application and simplify the description based on oriental or positional relationships shown in the accompanying drawings, not to indicate or imply that the apparatus or element referred must have a specific orientation, is constructed and operated in a specific orientation, and therefore cannot be understood as a limitation of the present application.

Unless otherwise specified and limited, the specific meanings of all technical and scientific terms used in the specification can be specifically understood by persons of ordinary skill in the art. The terms used in the specification of this application is for the purpose of describing specific embodiments only and is not intended to limit this application.

The following describes the embodiments of present application with reference to the drawings. In the description, the same elements are labeled with the same symbols, and their names and functions are the same. Therefore, detailed descriptions of them are not repeated.

### First Embodiment

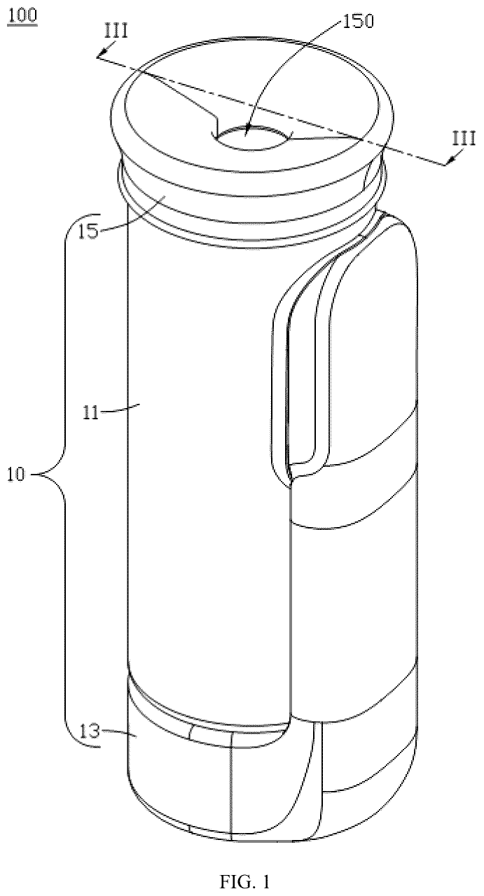

Referring to FIG. 1 to FIG. 4. As shown in FIG. 1, the sexual massage device 100 can perform negative pressure and clamping massage on a target part, such as a penis, to improve the user experience. Specifically, the sexual massage device 100 includes a housing 10, a clamping component 30, a negative pressure generating component 50, a control circuit board 70, and a battery 80. The housing 10 is capable of accommodating the target part, such as a penis. The clamping component 30, the negative pressure generating component 50, the control circuit board 70, and the battery 80 are installed inside the housing 10. An inner layer of the housing 10 is made of hard material. The control circuit board 70 and the battery 80 are connected to the clamping component 30 and the negative pressure generating component 50 respectively, allowing the battery 80 to power the clamping component 30 and the negative pressure generating component 50, and the control circuit board 70 to control the clamping component 30 and the negative pressure generating component 50 to start or close.

The housing 10 includes a massage body 11 with an opening 110 on one side, a base 13 disposed on the massage body 11, and a sealing member 15 installed at the opening 110.

The massage body 11 is cylindrical, and the opening 110 is disposed at one end of the massage body 11. A cavity 12 is defined in an interior of the massage body 11 to accommodate the target part, and the cavity 12 is communicated with the opening 110. An installation opening 113 is defined at a bottom and a side of the massage body 11 for installing the base 13. The base 13 is sealed and installed in the installation opening 113, and an installation space 130 is defined in the base 13. The base 13 is generally L-shaped and includes a first installation portion 131, a second installation portion 133, and a connecting portion 135 connecting the first installation portion 131 and the second installation portions 133. The first installation portion 131, the connecting portion 135, and the second installation portion 133 are sequentially communicated with each other. The first installation portion 131 is sealed and installed in the installation openings 113, keeping the cavity 12 sealed. The first installation portion 131 is configured to install the clamping component 30, and the second installation portion 133 is configured to install the negative pressure generating component 50. In this embodiment, the first installation portion 131 is disposed at one side of the massage body 11, the second installation portion 133 is disposed at a bottom of the massage body 11. A suction hole 121 and an air supply hole 123 are defined in a top surface of the first installation portion 131. The suction hole 121 and the air supply hole 123 are communicated with the cavity 12 of the massage body 11. In this embodiment, the clamping component 30 is installed in the first installation portion 131, and the negative pressure generating component 50, the control circuit board 70, and the battery 80 are installed in the base 13 of the housing 10, i.e., in the second installation portion 133.

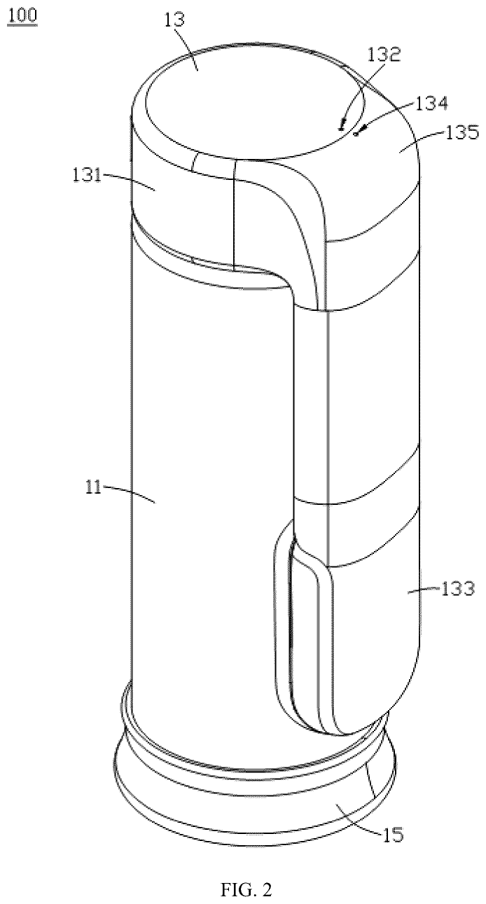

As shown in FIG. 2, an exhaust hole 132 and an air intake hole 134 are defined in a side wall of the second installation portion 133 of the base 13. The installation space 130 at the bottom of the massage body 11 is communicated with the external environment through the exhaust hole 132 and the air intake hole 134.

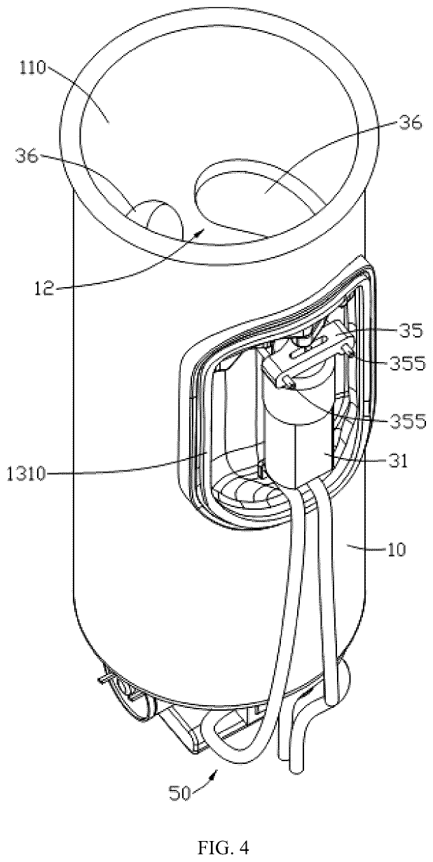

As shown in FIG. 1 and FIG. 4, the sealing member 15 is fixedly engaged with the opening 110 and has a central hole 150 communicated with the cavity 12. The target part enters the cavity 12 through the central hole 150 of the sealing member 15. The drawings in this application are schematic, and the size of the central hole 150 may be adjusted according to user needs, ensuring easy insertion and removal of the target part, such as a penis. A recess is defined in a side wall of the sealing member 15, and the recess is engaged with one end of the massage body 11. The sealing member 15 may be made of soft rubber. When the target part is inserted into the central hole 150, the surrounding portion of the central hole 150 rebounds and contacts the target part, keeping the cavity 12 sealed.

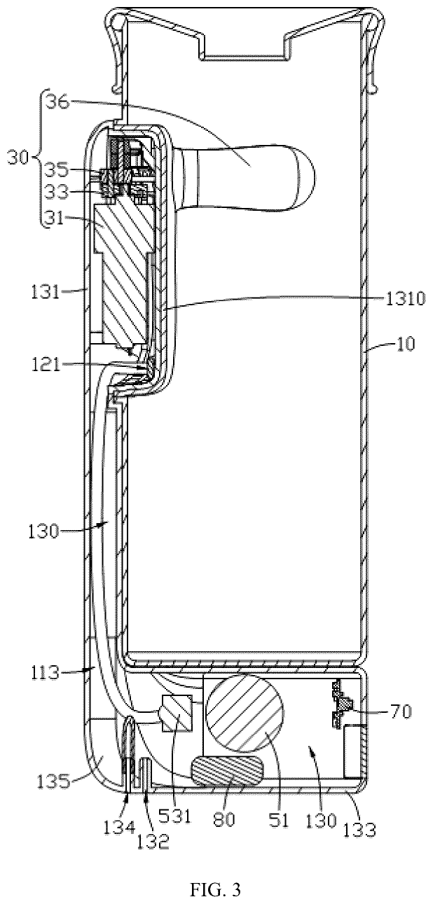

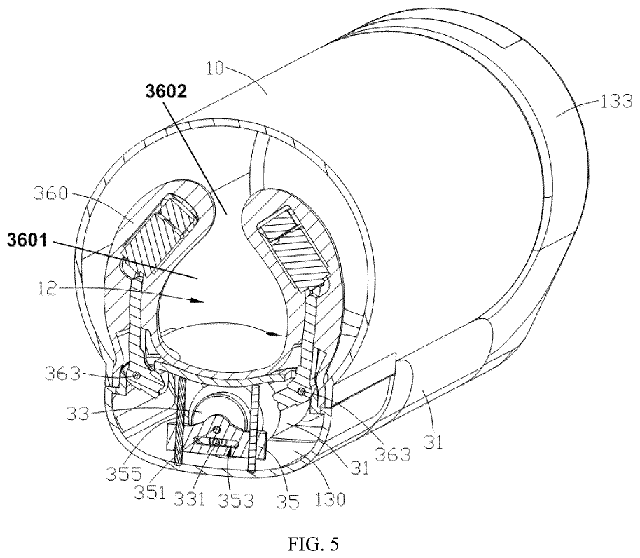

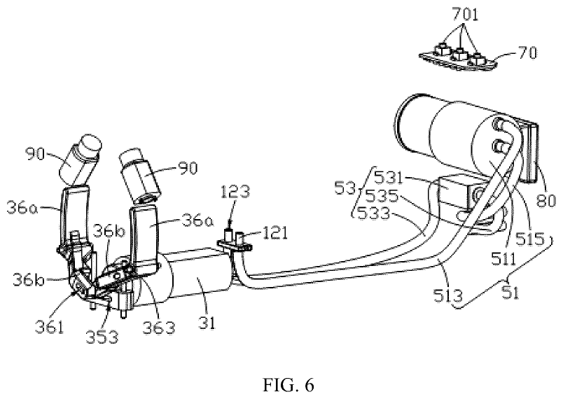

As shown in FIG. 3, FIG. 4, FIG. 5 and FIG. 6, the clamping component 30 is installed in the first installation portion 131, and the clamping component 30 includes a driving motor 31, a rotating member 33, a transmission member 35, and two swing rods 36. The driving motor 31 is fixed in the first installation portion 131. The rotating member 33 is connected to an output shaft (not shown) of the driving motor 31, resulting the rotating member 33 to rotate driven by the driving motor 31. Two sides of the transmission member 35 are connected to the rotating member 33 and the two swing rods 36 respectively, and the transmission member 35 drives the swing rods 36 to move up and down. In this embodiment, the rotating member 33 is an eccentric plate, and the transmission member 35 is a slider. The rotating member 33 is fixed on the output shaft of the driving motor 31, and an eccentric post 331 is formed on one end surface of the rotating member 33. Driven by the rotating member 33, the transmission member 35 is slidable up and down in the first installation portion 131.

Specifically, a transmission shaft 351 is protruded on a side of the transmission member 35 away from the rotating member 33. An elongated moving hole 353 is defined in a middle of the transmission member 35 along a length direction of the transmission member 35 to allowing the eccentric post 331 of the rotating member 33 to pass through. The transmission shaft 351 extends from a surface of the transmission member 35 away from the rotating member 33 towards the direction away from the driving motor 31. To ensure the stability of the rotating member 35, two ends of main body of the transmission member 35 further form guiding shafts 355 perpendicularly passing through the transmission member 35. Two ends of the guiding shafts 355 are fixed on upper and lower covers of the first installation portion 131, and two ends of the transmission member 35 are movably installed on the guiding shafts 355, allowing the transmission member 35 to slide up and down along the guiding shafts 355. Part of the two swing rods 36 are rotatably installed to the first installation portion 131, and the other part of the two swing rods 36 extend out of the first installation portion 131 and into the cavity 12. The two swing rods 36 are symmetrically arranged in the cavity 12 of the massage body 11 and form a receiving space 3601 to accommodate the target part therebetween. The two swing rods 36 face each other to clamp and massage the target part inserted into the massage body 11 from two side, i.e., left-right sides. Further, inner walls of the two swing rods 36 are curved, that is, the two swing rods 36 extend from one side of the first installation portion 131 and forms the circular receiving space therebetween. When the target part enters the receiving space, the target part directly contacts the inner walls of the two swing rods 36.

Specifically, the receiving space 3601 has a notch 3602 at one side; when the clamping component 30 clamps the penis, the notch 3602 has a first size, when the clamping component 30 releases the penis, the notch 3602 has a second size, and a difference between the first size and the second size is larger than 0 and smaller than 100 mm.

In this embodiment, the two swing rods 36 are generally shaped like slightly curved fingers. As the driving motor 31 drives the rotating member 33 to rotate, the two swing rods 36 are pushed up to move apart from each other or pulled down to move closer driven by the transmission member 35. The side walls of the two swing rods 36 contact the target part, thereby providing a clamping massage to the target part from two sides. The target part may enter the receiving space between the two swing rods 36 through the central hole 150 of the sealing member 15 to be massaged.

More specifically, the two swing rods 36 have the same structure, and are both C-shaped. The two swing rods 36 each includes a swing arm 36a and a connecting arm 36b integrally formed. A lower end of the connecting arm 36b is overlapped and installed on the transmission shaft 351. The swing arm 36a is bent and extended upward from an upper end of the connecting arm 36b, and protrudes from a top of the first installation portion 131 into the cavity 12. When the transmission shaft 351 moves downward, the two connecting arms 36b move downward, and the two swing arms 36a move closer. When the transmission shaft 351 moves upward, the two connecting arms 36b move upward, and the two swing arms 36a move apart from each other. Therefore, the two swing rods 36 perform a clamping action and a releasing action on the massage part. The swing arms 36a of the two swing rods 36 are generally arc-shaped and face each other, so as to evenly apply clamping force on the target part from two sides. An elongated sliding slot 361 is defined in an end of the connecting arm 36b away from the swing arm 36a. The transmission shaft 351 is inserted into the sliding slot 361 to drive the connecting arm 36b. Additionally, a connecting part for connecting the connecting arm 36b and swing arm 36a is connected to an upper cover 1310 of the first installation portion 131 via a pivot shaft 363, allowing the entire swing rod 36 to rotate around the pivot shaft 363.

More Specifically, when the transmission shaft 351 is moved downward in the sliding slots 361 of the two swing rods 36 driven by the transmission member 35, the connecting arm 36b, together with the swinging arm 36a, is pulled downward. At this time, the swing arms 36a of the two swing rods 36 move in a direction closer to each other. Subsequently, the rotating member 33 rotates in an inverse direction, causing the transmission member 35 to drive the transmission shaft 351 to move upward within the sliding slots 361, thereby pushing the entire swing rods 36 to move upward. At this time, the swing arms 36a of the two swing rods 36 move in a direction away from each other. In this way, the two swing rods 36 may perform the clamping action and the releasing action repeatedly and alternately.

In this embodiment, an outer wall of each swing rod 36 is covered with a protective cover 360 (refer to FIG. 5). The protective cover 360 covers outer walls of the swing arm 36a and connecting arm 36b (as shown in FIG. 5). A vibration motor 90 is disposed adjacent to a top end of the swing arm 36a in the protective cover 360, allowing the swing arm 36a to vibrate while swinging, thus providing a better massage effect. Wherein, the protective cover 360 may be made of soft material.

When using the clamping massage function of the sexual massage device 100, the target part is inserted into the massage space of the massage body 11 through the space between the two swing rods 36. Then, the driving motor 31 is started via a switch 701 on the control circuit board 70 and the rotating member 33 is driven to rotate alternately clockwise and counterclockwise, thereby moving the transmission member 35 up and down via the eccentric post 331. Since the transmission shaft 351 of the transmission member 35 is connected within the sliding slot 361 at the lower end of the swing rod 36, the transmission shaft 351 is slidable along an inner wall of the sliding slot 361. Therefore, the connecting arm 36b of each swing rod 36 is driven to move up and down, thus causing the two swing rods 36 in left and right sides of the cavity 12 of the massage body 11 to swing back and forth, moving closer or apart from each other. In this way, the clamping massage is performed on the target part in the receiving space between the two swing rods 36. Optionally, the vibration motor 90 is installed at the upper end of the swing arm 36a away from the connecting arm 36b. During the clamping massage by the swing arms 36a of the two swing rods 36, the vibration motors 90 at two sides may provide a vibration massage effect on the target part.

Referring to FIG. 3, FIG. 4 and FIG. 6, the negative pressure generating component 50 includes a negative pressure generating portion 51 and an air supply portion 53. The negative pressure generating portion 51 includes a suction device 511, a first connecting pipe 513, and a second connecting pipe 515. The suction device 511 is installed in the second installation portion 133 of the base 13. One end of the first connecting pipe 513 is connected to the suction device 511, and the other end of the first connecting pipe 513 is connected to the suction hole 121 of the first installation portion 131 via the connecting portion 135. One end of the second connecting pipe 515 is connected to the suction device 511, and the other end of the second connecting pipe 515 is connected to the exhaust hole 132 of the second installation portion 133.

When the suction device 511 is started, the suction device 511 sucks the gas in the cavity 12 of the massage body 11 through the first connecting pipe 513, creating a negative pressure state in the cavity 12 of the massage body 11. Then, the gas sucked by the suction device 511 is discharged to an outside of the second installation portion 133 of the base 13 via the first connecting pipe 513 and the exhaust hole 132. In this embodiment, the suction device 511 is an electric air pump, an electric water pump, or a manual suction device, as long as it can suck gas.

The air supply portion 53 is installed in the second installation portion 133 of the base 13, and includes an electromagnetic valve 531, a first air delivery pipe 533, and a second air delivery pipe 535. The electromagnetic valve 531 is fixed in the second installation portion 133 of the base 13. One end of the first air delivery pipe 533 is connected to the electromagnetic valve 531, and the other end of the first air delivery pipe 533 is connected to the air supply hole 123 of the first installation portion 131 via the connecting portion 135. One end of the second air delivery pipe 535 is connected to the electromagnetic valve 531, and the other end of the second air delivery pipe 535 is connected to the air intake hole 134. When the electromagnetic valve 531 is started, the electromagnetic valve 531 supplies external air to the cavity 12 of the massage body 11 through the second air delivery pipe 535 and the first air delivery pipe 533, making the cavity 12 of the massage body 11 in a non-negative pressure state.

The suction device 511, the electromagnetic valve 531, and the driving motor 31 are connected to the control circuit board 70 and the battery 80. The battery 80 powers the suction device 511, the electromagnetic valve 531, and the driving motor 31. The control circuit board 70 controls the activation of the suction device 511, the electromagnetic valve 531, and the driving motor 31, allowing the control circuit board 70 to activate the suction device 511, the electromagnetic valve 531, and the driving motor 31 according to a preset program or via manual operation of the switch 701 on the control circuit board 70, as needed.

When the suction device 511 is started, the electromagnetic valve 531 is closed to ensure the cavity 12 of the massage body 11 remains in the negative pressure state during a working period of the suction device 511. After the suction device 511 works for a preset time, the suction device 511 is closed and the electromagnetic valve 531 is started according to the set program. Alternatively, a negative pressure sensor may be installed in the cavity 12 of the massage body 11. When the negative pressure sensor detects a preset negative pressure value, the suction device 511 is closed and the electromagnetic valve 531 is started. In this application, the actions of the suction device 511 and electromagnetic valve 531 may be controlled as needed. That is, the electromagnetic valve 531 and suction device 511 may be alternately started according to a preset program or user preference.

When preforming the negative pressure function of the sexual massage device 100, the target part is inserted into the cavity 12 through the central hole 150 of the sealing member 15, so that the target part seals the central hole 150 of the sealing member 15 to keep the cavity 12 of the massage body 11 being sealed. Then, the suction device 511 is started via the switch 701 connected to the control circuit board 70 on the sexual massage device 100. When the suction device 511 is started, the suction device 511 sucks the gas in the cavity 12 of the massage body 11 through the first connecting pipe 513, creating the negative pressure state in the cavity 12 of the massage body 11. After that, the gas sucked by the suction device 511 is discharged to the external environment via the second connecting pipe 515. At this time, the target part is pressed by the negative pressure in the cavity 12 of the massage body 11, providing a massage effect. After the user achieves the desired pressure effect, the suction device 511 is shut off and the electromagnetic valve 531 is started via the switch 701 on the control circuit board 70. When the electromagnetic valve 531 is started, the electromagnetic valve 531 allows external air to enter the cavity 12 of the massage body 11 through the second air delivery pipe 535 and the first air delivery pipe 533, thereby making the cavity 12 of the massage body 11 in a non-negative pressure state.

### Second Embodiment

In the second embodiment, only the parts different from the first embodiment are described, and other parts refer to the description of the first embodiment.

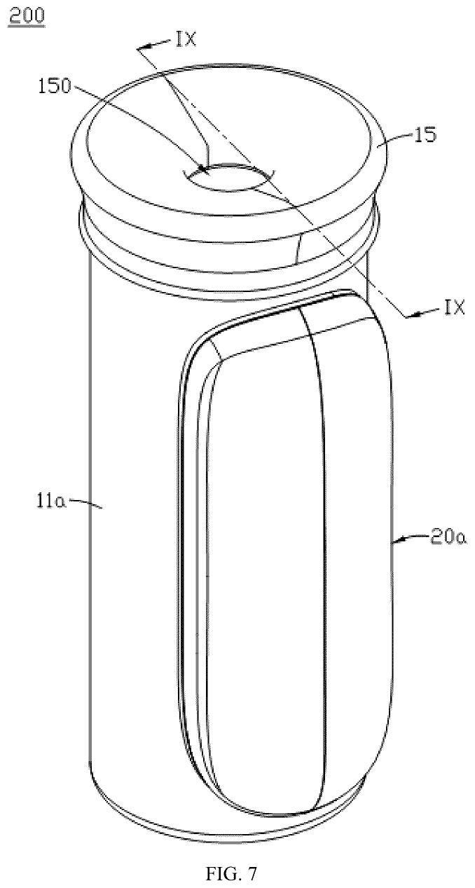

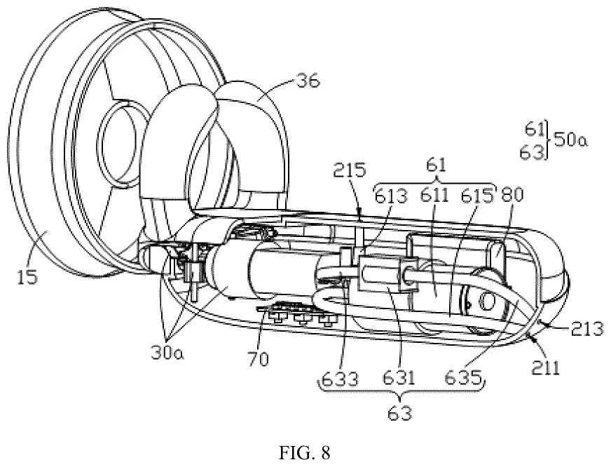

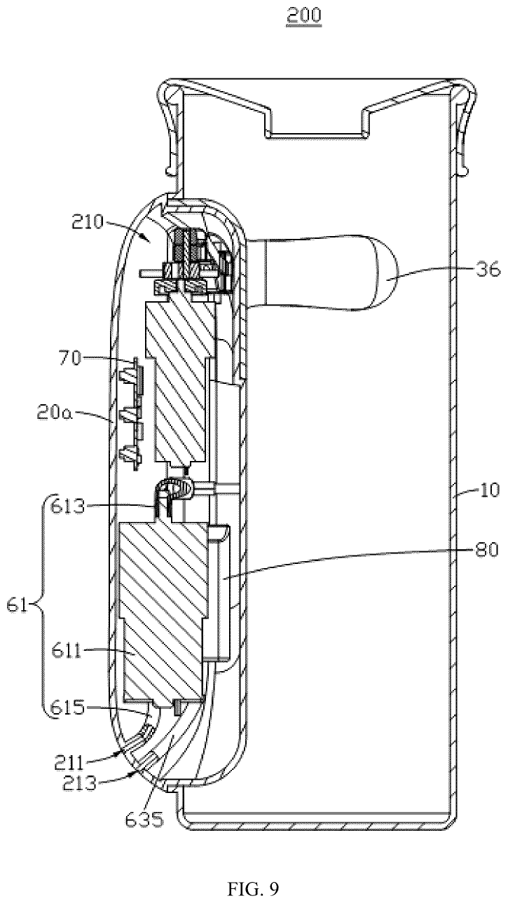

As shown in FIG. 7, FIG. 8 and FIG. 9, the sexual massage device 200 of the second embodiment is similar to the sexual massage device 100 of the first embodiment in terms of the shape of the massage body, the components of the clamping component, and the simultaneous clamping and negative pressure massage functions. The main difference between the sexual massage device 200 of the second embodiment and the sexual massage device 100 of the first embodiment lies in the structure of the installation portion. Specifically, an installation portion 20a of the sexual massage device 200 in the second embodiment only includes the part equivalent to the first installation portion 131 of the sexual massage device 100 in the first embodiment. A clamping component 30a and a negative pressure generating component 50a are installed on the same side of the massage body 11. In this case, the installation portion 20a of the sexual massage device 200 is different in shape and larger in size compared to the installation portion (i.e. the first installation portion 131, the connecting portion 135, and the second installation portion 133) of the sexual massage device 100. Additionally, a rear end of the installation portion 20a has an exhaust hole 211 and an air intake hole 213 opened diagonally downward.

Specifically, the negative pressure generating component 50a of the sexual massage device 200 includes a negative pressure generating portion 61 and an air supply portion 63. The negative pressure generating portion 61 includes a suction device 611, a first connecting pipe 613, and a second connecting pipe 615. The suction device 611 is installed in an installation space 210 of the installation portion 20a. One end of the first connecting pipe 613 is connected to the suction device 611, and the other end is connected to the suction hole 215 on a top surface of the installation portion 20a. One end of the second connecting pipe 615 is connected to the suction device 611, and the other end is communicated with the external environment via the exhaust hole 211. When the suction device 611 is started, the suction device 611 sucks the gas in the cavity 12 of the massage body 11 through the first connecting pipe 613, creating a negative pressure state in the cavity 12 of the massage body 11. Then, the gas sucked by the suction device 511 is discharged to the outside of the massage body 11 through the first connecting pipe 613 and the exhaust hole 211.

The air supply portion 63 includes an electromagnetic valve 631, a first air delivery pipe 633, and a second air delivery pipe 635. The electromagnetic valve 631 is located at a connecting position of the first delivery pipes 633 and the second air delivery pipes 635, and positioned diagonally above the suction device 611. The first delivery pipes 633 and the second air delivery pipes 635 extend generally parallel to the second connecting pipe 615. One end of the first air delivery pipe 633 is connected to the electromagnetic valve 631, and the other end is directly communicated with the cavity 12 of the massage body 11. That is, no air supply hole is defined in a top of the installation portion 20a of the sexual massage device 200 in the second embodiment. One end of the second air delivery pipe 635 is connected to the electromagnetic valve 631, and the other end is connected to the air intake hole 213. When the electromagnetic valve 631 is started, the electromagnetic valve 631 supplies external air to the cavity 12 of the massage body 11 through the second air delivery pipe 635 and the first air delivery pipe 633, thereby making the cavity 12 in a non-negative pressure state.

Again, in the sexual massage device 200, the control circuit board 70 is placed parallel to the driving motor 31 and is below the driving motor 31, and the battery 80 is vertically housed in a side wall of the installation portion 20a inside the suction device 611. The connection relationship and functional principles of the control circuit board 70 and the battery 80 are the same as in the first embodiment and will not be repeated.

Additionally, the specific working principles of the clamping component 30a and the negative pressure generating component 50a are the same as in the sexual massage device 100 of the first embodiment and will not be repeated.

It should be understood that in the sexual massage device 100 and the sexual massage device 200 of the application, the clamping massage function based on the clamping component and the negative pressure clamping massage function based on the negative pressure generating component may be performed separately or simultaneously controlled by the control circuit board 70.

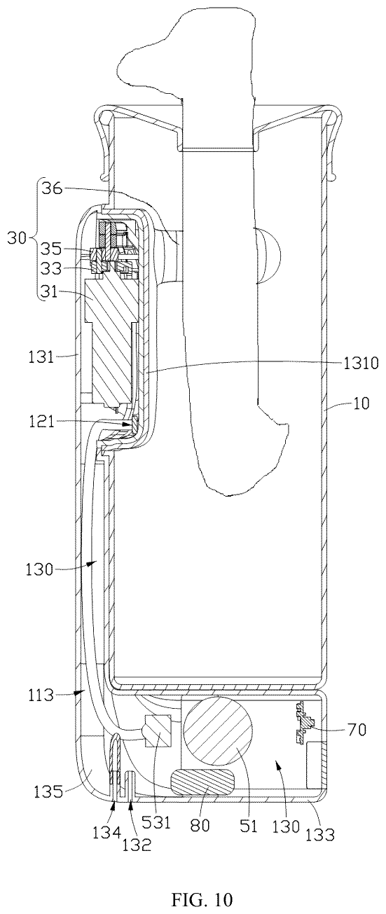

It should be understood that in one application, the user may also insert the target part into the cavity of the housing 10 and obtain the corresponding massage function via the swing rods and negative pressure generating component. At this time, since the sealing member 15 is made of elastic silicone, the user's organ may gradually push the central hole 150 to expand towards two side. For example, the user may insert a penis of a man into the cavity 12 of the sexual massage device 100 to stimulate the penis, thus achieving a good sexual experience. FIG. 10 shows yet another application of the sexual massage device of the present application. As shown in FIG. 10, a penis of a man is inserted into the cavity of the housing 10 through the central hole 150 of the sealing member 15, and the penis seals the central hole 150 to keep the cavity 12 being sealed. When the sexual massage device 100 is turned on, the two swing rods 36 swing in the cavity so as to repeatedly and alternately clamp and release the penis. At the same time, the suction device 511 sucks the gas in the cavity 12, creating the negative pressure state in the cavity 12 of the massage body 11. Thus, the penis is pressed by the negative pressure. Certainly, the sexual massage device 200 of the second embodiment may also be used to massage the target part.

### Third Embodiment

In the third embodiment, only the parts different from the first embodiment are described, and other parts refer to the description of the first embodiment.

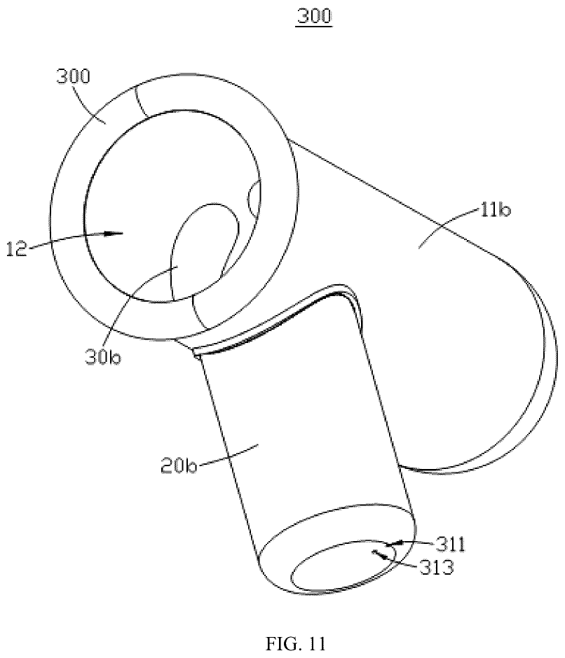

As shown in FIG. 11, a sexual massage device 300 of the third embodiment is similar to the sexual massage device 100 of the first embodiment and the sexual massage device 200 of the second embodiments in terms of the general shape of the massage body, the components of the clamping component, and the simultaneous clamping and negative pressure massage functions. The main differences are as follows: Firstly, the sexual massage device 300 does not have a sealing member to seal an opening 110 of a massage body 11b. Instead, the opening 110 is defined with a rolled edge structure 310 flipped outward along a circumferential direction. The rolled edge structure is preferably made of elastic material to prevent pinching the target part. Additionally, a bottom of the massage body 11b is not flat and circular as in the first and second embodiments but is arc-shaped. Secondly, an installation portion 20b of the sexual massage device 300 is generally cylindrical and is disposed on a position of the massage body 11b adjacent to the rolled edge structure 310 in a manner generally perpendicular to the massage body 11b. A bottom surface of a lower end of the installation portion 20b is flat and circular, and an exhaust hole 311 and an air intake hole 313 are defined in the bottom surface of the installation portion 20b. Thirdly, the structure and driving principle of a clamping component 30b for the clamping massage function in the sexual massage device 300 are significantly different from those of the clamping component 30 in the first and second embodiments. Finally, the components and working principles of a negative pressure generating component 50b in the sexual massage device 300 are the same as in the first and second embodiments, but only the orientation of the air supply portion and the layout of the connecting and air delivery pipes are different, and will not be repeated. Below, the specific structure and principle of the clamping component 30b are described in detail.

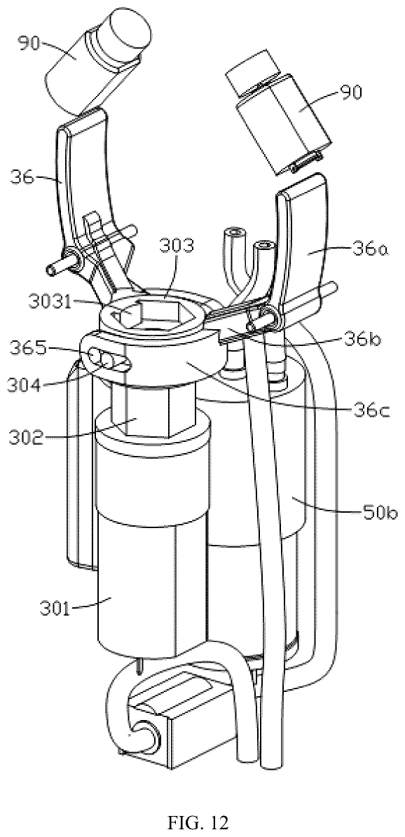

As shown in FIG. 12, specifically, the clamping component 30b of the sexual massage device 300 includes a driving motor 301, an output shaft 302, a fixing ring 303, two fixing posts 304 and two swing rods 36 left-right disposed. The driving motor 301 is a telescopic motor, and an output shaft 302 thereof may move along a direction away from or towards a motor body. The output shaft 302 is generally hexagonal prismoid, with a groove (not labeled) defined along one side wall of prismoid. The fixing ring 303 is generally a hollow ring, and the fixing ring 303 has a continuous arc on an outer wall thereof and a hexagonal inner wall. A protrusion 3031 corresponding to the groove is formed on the inner wall of the fixing ring 303 for slidably engaged with the groove. The two fixing posts 304 protrude outward from opposite positions on the outer wall of the fixing ring 303. The two swing rods 36 each also includes a swing arm 36a and a connecting arm 36b. In this embodiment, a generally arc-shaped installation arm 36c is formed on a lower end of each connecting arm 36b, and the installation arm 36c extends along the outer wall of the fixing ring 303, i.e., the installation arm 36c generally surrounds the outer wall of the fixing ring 303. Additionally, a receiving slot 365 is defined in the installation arm 36c along a length direction of the installation arm 36c. The two installation arms 36c face each other, so that the two fixing posts 304 are received in the receiving slots 365 respectively.

When the driving motor 301 is started, the output shaft 302 of the driving motor 301 moves up and down, thus driving the fixing ring 303 around the output shaft 302 to move axially up and down. During this process, the protrusion 3031 on the inner wall of the fixing ring 303 slides longitudinally along the groove, the installation arm 36c surrounding the outer wall of the fixing ring 303 moves up and down together with the fixing ring 303 driven by the fixing post 304, and the swing arm 36a is pulled to move by the connecting arms 36b connected to each installation arm 36c. As the two connecting arms 36b and installation arms 36c move down ward, the two swing arms 36a are pulled downward and move closer. As the two connecting arms 36b and installation arms 36c move upward, the two swing arms 36a are pushed upward and move apart from each other. Thus, as the driving motor 301 works with high speed, the two swing rods 36 of the sexual massage device 300 in this embodiment may perform repeated movements closer or apart from each.

Referring to FIG. 11, similarly, the user may also insert the target part into the sexual massage device 300 of the third embodiment to obtain the clamping or negative pressure massage function. Certainly, the sexual massage device 300 may also be used for cupping therapy on the back. Further, the sexual massage device 300 may also be used to stimulate sexual organs such as a penis of a man.

### Fourth Embodiment

Following, please referring to FIG. 13 to FIG. 16, a sexual massage device 400 of the fourth embodiment of the present application is detailed described. Compared to the sexual massage devices 100-300, the sexual massage device 400 also has the clamping and negative pressure massage functions, and the main differences are: A clamping component 30c is installed outside a massage body 11c and includes two pairs of parallel swing rods 36. The two pairs of parallel swing rods 36 are adjacent to an opening 110 of the massage body 11c and are generally parallel to each other. A receiving space defined between the two pairs of swing rods 36 is communicated with the opening 110 of the massage body 11c. Additionally, the integral shape of the massage body 11c is significantly different from that of the sexual massage devices 100-300, and the structure of the cavity of the massage body 11c is also different from that of the sexual massage devices 100-300.

Specifically, as shown in FIG. 14, an operation panel 111 is disposed on an upper surface of the housing of the massage body 11c, and the operation panel 111 has buttons of power switch, control switch, and mode switch etc. thereon. An inner surface of the cavity of the massage body 11c has a soft rubber layer 118, and the soft rubber layer 118 of an entrance is capable of tightening or even sealing the opening 110. A space between the outer side of the soft rubber layer 118 and the housing 10 is filled with air. Additionally, the inner surface of the soft rubber layer 118 inside the cavity 12c forms a plurality of soft rubber massage rods 1181 to provide a better massage effect on the target part such as the penis.

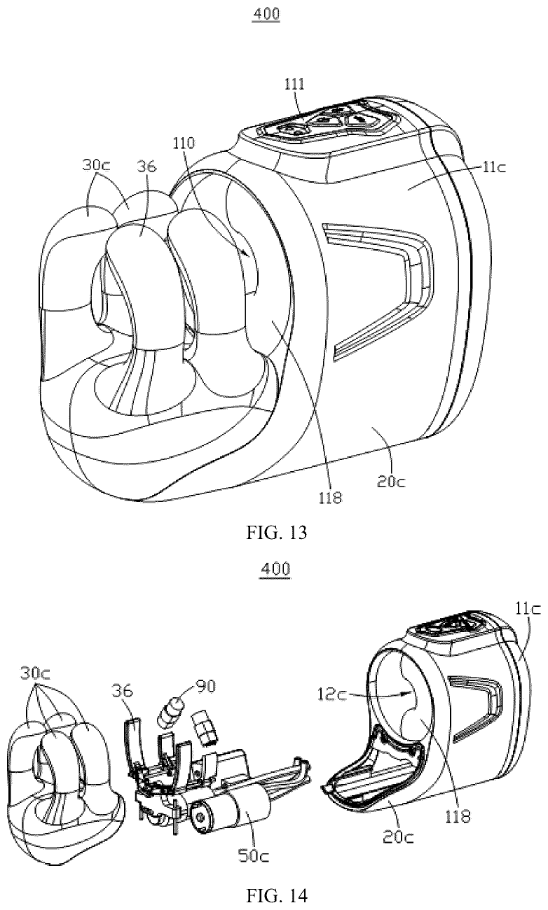

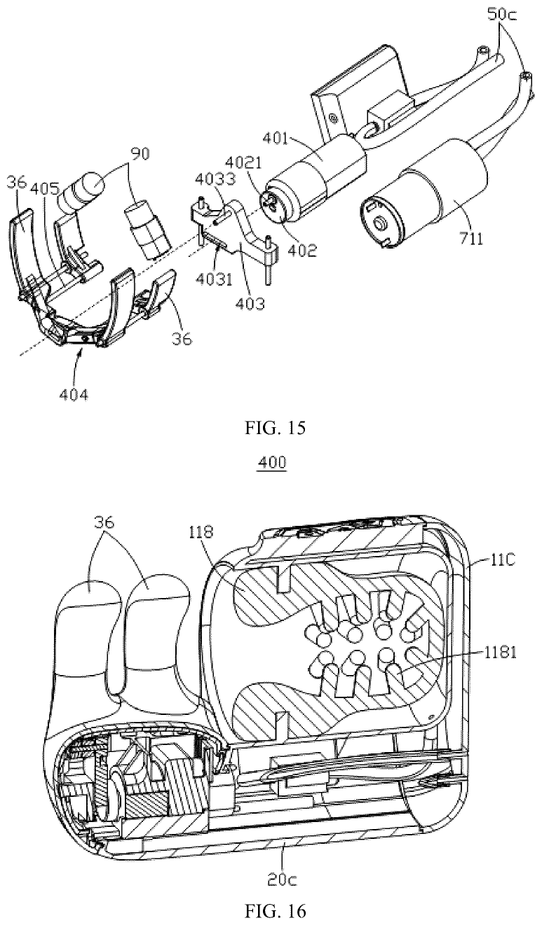

Please referring to FIG. 15 and FIG. 16, the sexual massage device 400 includes a clamping component 30c and a negative pressure generating component 50c. Wherein, the clamping component 30c includes a driving motor 401, a rotating member 402, a transmission member 403, and a swing assembly 404. The swing assembly 404 includes two pairs of parallel swing rods 36, with one pair (also called the active swing rods 36 in this embodiment) spaced apart from the other pair (the driven swing rods 36) via two connecting shafts 405. When the driving motor 401 drives the rotating member 402 to rotate, an eccentric post 4021 on the rotating member 402 passes through a sliding slot 4031 defined in a bottom portion of the transmission member 403, thus driving the transmission member 403 to move up or down. Since the transmission shaft 4033 formed on a top portion of the transmission member 403 passes through the active swing rods 36, the active swing rods 36 is pulled downward or pushed upward. When pulled downward, the two active swing rods 36 move closer. When pushed upward, the two active swing rods 36 move apart from each other. During this process, the pair of driven swing rods 36 move up and down synchronously with the pair of active swing rods 36. This repeated moving away and closing swinging action makes the clamping massage function performed on the target part.

The components and working principles of a negative pressure generating component 50c are the same as in the first to third embodiments and will not be repeated. The difference are: an installation portion 20c to house the negative pressure generating component 50c is formed below the massage body 11c forms, and the negative pressure generating component 50c is entirely housed in the installation portion 20c. The installation portion 20c and massage body 11c are connected as a whole one, forming a generally whistle-like shape. Upper ends of the air delivery and connecting pipes of the negative pressure generating component 50c are communicated with the cavity 12c of the massage body 11c. The negative pressure generating component 50c discharges air filled between the soft rubber layer of the massage body 11c and the housing 10 via a suction device 711 (air pump), creating a negative pressure state in the cavity 12c. With repeatedly and alternately discharging air from the cavity 12c and supplying air to the cavity 12c via the negative pressure generating component 50c, a desired pressure massage function is achieved.

Please referring to FIG. 13 again, the sexual massage device 400 of the present application is particularly suitable for massaging organ of human such as a penis of man. During using the sexual massage device 400, the user's organ is housed between the two pairs of swing rods 36, and the organ of human is inserted into the cavity 12c of the massage body 11c. While the two pairs of swing rods 36 perform the clamping massage action on the organ of human, the negative pressure generating component 50c may apply pressure from the outside on the organ of human and release it appropriately. It should be understood that the sexual massage device 400 of the present application may also massage sexual organs such as a penis of human.

### Fifth Embodiment

In the fifth embodiment, only the parts different from the first embodiment are described, and other parts refer to the description of the first embodiment.

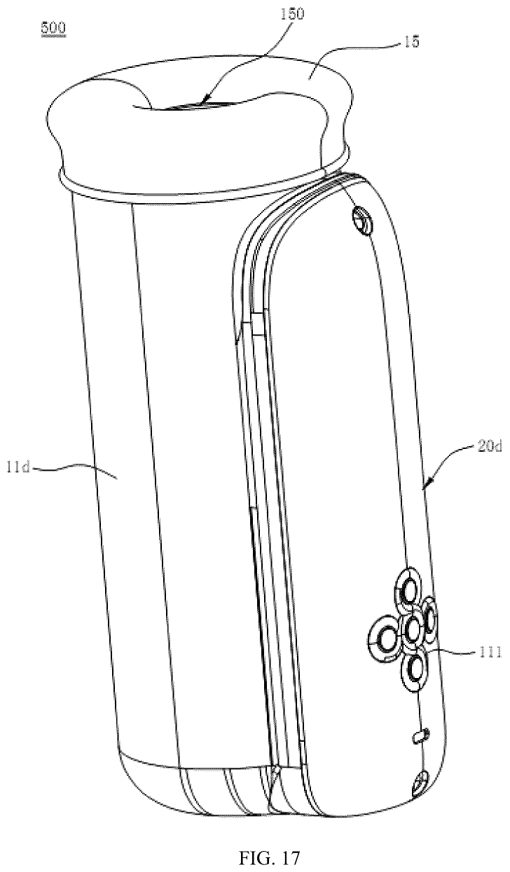

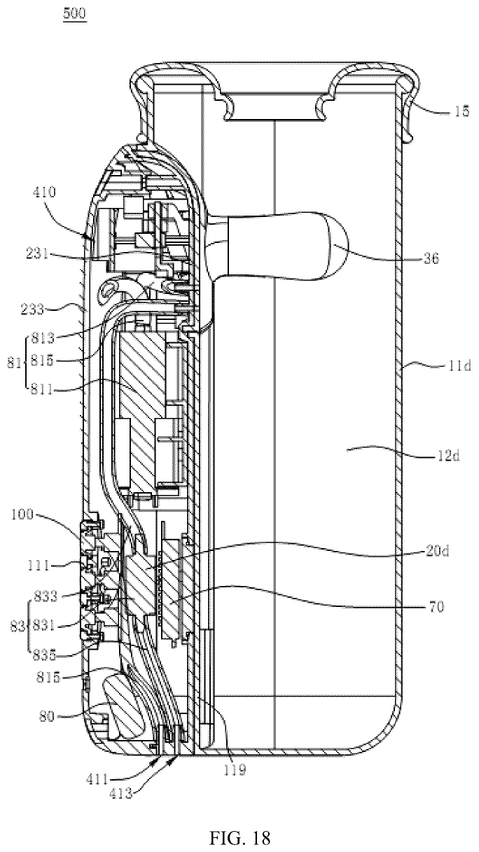

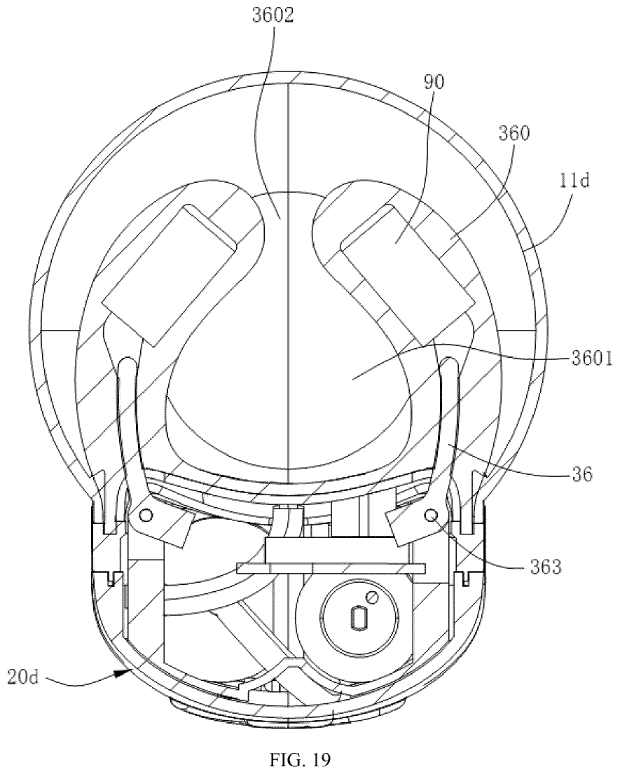

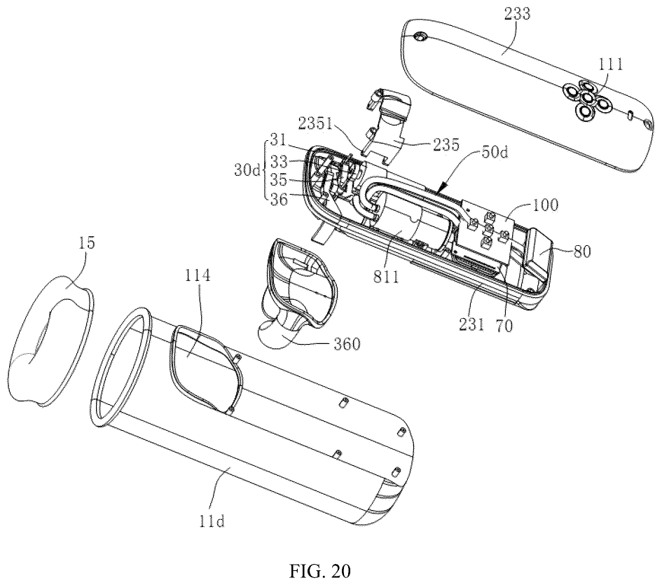

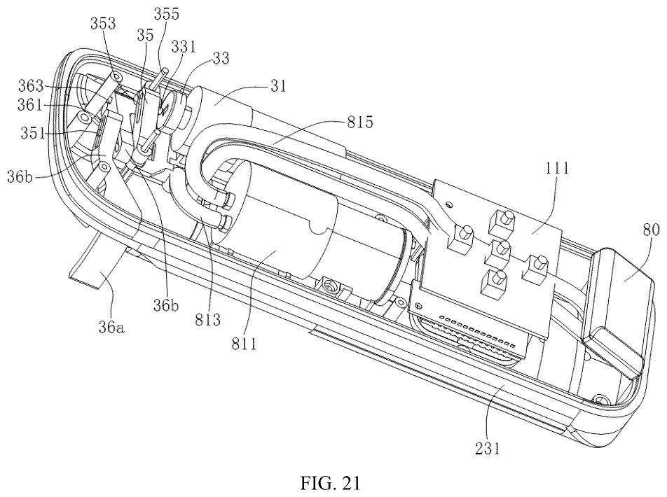

As shown in FIG. 17 to FIG. 21, the sexual massage device 500 of the fifth embodiment is similar to the sexual massage device 100 of the first embodiment in terms of the shape of the massage body, the components of the clamping component, and the simultaneous clamping and negative pressure massage functions. The main difference between the sexual massage device 500 of the fifth embodiment and the sexual massage device 100 of the first embodiment lies in the structure of the installation portion. Specifically, an installation portion 20d of the sexual massage device 500 in the fifth embodiment only includes the part equivalent to the first installation portion 131 of the sexual massage device 100 in the first embodiment. A clamping component 30d and a negative pressure generating component 50d are installed on the same side of the massage body 11d. In this case, the installation portion 20d of the sexual massage device 500 is different in shape and larger in size compared to the installation portion (i.e. the first installation portion 131, the connecting portion 135, and the second installation portion 133) of the sexual massage device 100. Additionally, a bottom of the installation portion 20d defines an exhaust hole 411 and an air intake hole 413.

Specifically, the negative pressure generating component 50d of the sexual massage device 500 includes a negative pressure generating portion 81 and an air supply portion 83. The negative pressure generating portion 81 includes a suction device 811, a first connecting pipe 813, and a second connecting pipe 815. The suction device 811 is installed in an installation space 410 of the installation portion 20d. One end of the first connecting pipe 813 is connected to the suction device 811, and the other end is connected to a cavity 12d of the installation portion 20d. One end of the second connecting pipe 815 is connected to the suction device 811, and the other end is communicated to the external environment via the exhaust hole 411. When the suction device 811 is started, the suction device 811 sucks the gas in the cavity 12d of the massage body 11d through the first connecting pipe 813, creating a negative pressure state in the cavity 12d. Then, the gas sucked by the suction device 811 is discharged to the outside of the massage body 11d via the second connecting pipe 815 and the exhaust hole 411.

The air supply portion 83 includes an electromagnetic valve 831, a first air delivery pipe 833, and a second air delivery pipe 835. The electromagnetic valve 831 is located at the connection of the first delivery pipes 833 and the second air delivery pipes 835, positioned diagonally above the suction device 811. One end of the first air delivery pipe 833 is connected to the electromagnetic valve 831, and the other end is directly communicated with the cavity 12d of the massage body 11d. One end of the second air delivery pipe 835 is connected to the electromagnetic valve 831, and the other end is connected to the air intake hole 413. When the electromagnetic valve 831 is started, the electromagnetic valve 831 supplies external air to the cavity 12d of the massage body 11d through the second air delivery pipe 835 and the first air delivery pipe 833, thereby making the cavity 12d in a non-negative pressure state.

The connection relationship and functional principles of the control circuit board 70 and the battery 80 are the same as in the first embodiment and will not be repeated. Additionally, the specific working principles of the clamping component 30d and the negative pressure generating component 50d in the fifth embodiment are the same as in the sexual massage device 100 of the first embodiment and will not be repeated.

Specifically, In the fifth embodiment, the installation portion 20d is installed on an outside wall 119 at one side of the massage body 11d. More specifically, the installation portion 20d is attached to the outside wall 119 of the massage body 11d and sealed at a through-hole 114 on one side of the massage body 11d, thereby making the cavity 12d in a sealed state. Specifically, the installation portion 20d includes a base cover 231 and a top cover 233. The base cover 231 is attached to the outside wall 119 of the massage body 11d, and the top cover 233 is engaged with the base cover 231 to form the installation space 410. Specifically, both the base cover 231 and the top cover 233 may be transparent shells, allowing the internal structures in the installation portion 20d to be visible through the installation portion 20d. The swing rod 36 extends into the cavity 12d through the through-hole 114 to massage the target part inserted into the cavity 12d.

Specifically, the clamping component 30 defines a receiving space 3601 to receive the penis, and the receiving space 3601 has a notch 3602 at one side; when the clamping component 30 clamps the penis, the notch 3602 has a first size, when the clamping component 30 releases the penis, the notch 3602 has a second size, and a difference between the first size and the second size is larger than 0 and smaller than 100 mm.

In the sexual massage device 500 of this embodiment, the driving motor 21 and the suction device 811 are arranged side by side in one end of the installation portion 20d. The control circuit board 70, the battery 80, and the display screen 100 are located at the other end of the installation portion 20d. The riving motor 21 and the suction device 811 are disposed between the swing rod 36 and the control circuit board 70, and the battery 80 is obliqued relative to the control circuit board 70. Specifically, the control circuit board 70 is positioned below the electromagnetic valve 831, and the display screen 100 is positioned above the electromagnetic valve 831. An operation panel 111 is disposed on an upper surface of the housing of the massage body 11c, and the operation panel 111 has buttons of power switch, control switch, and mode switch etc. thereon. The operation panel 111 is located above the display screen 100 and has an area than smaller that of the display screen 100. Since the top cover 233 is transparent, the content displayed on the display screen 100 inside the installation portion 20d can be seen through the top cover 233. The battery 80 is disposed adjacent to an end of the installation portion 20d which is away from the swing rod 36. The installation portion 20d further includes a mounting seat 235 located between the base cover 231 and the top cover 233. The mounting seat 235 is fixed relative to the base cover 231, and the pivot 363 of the clamping component 30d is rotatably connected to a pivot hole 2351 of the mounting seat 235.

It should be understood that, as a variational embodiment, the clamping and releasing massage function based on the clamping components 30, 30a, 30b, 30c, 30d in the present application may also be achieved by two sliders being movable towards each other on an inner wall of the housing of the massage body 11. Specifically, the two sliders are located on two opposite sides of the cavity 12 of the massage body 11 and are movable closer or apart from each other.

In summary, the sexual massage devices 100, 200, 300, 400, 500 provided by the present application apply pressure to the penis, the organ of human from the outside via the negative pressure generating component, at the same time the at least two swing rods of the clamping components 30, 30a, 30b, 30c, 30d repeatedly and alternately perform clamping and releasing action, thus achieving both pressure massage and pinching massage. Therefore, the sexual massage devices 100, 200, 300, 400, 500 provide multi-functions and a good user experience.

### Sixth Embodiment

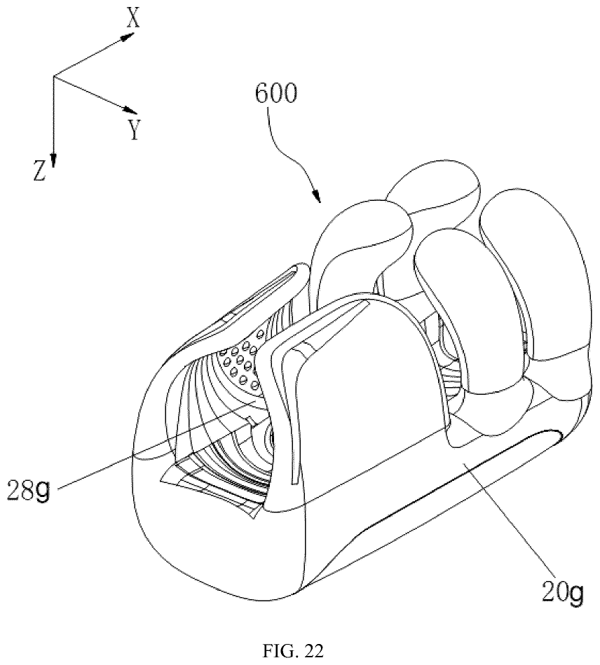

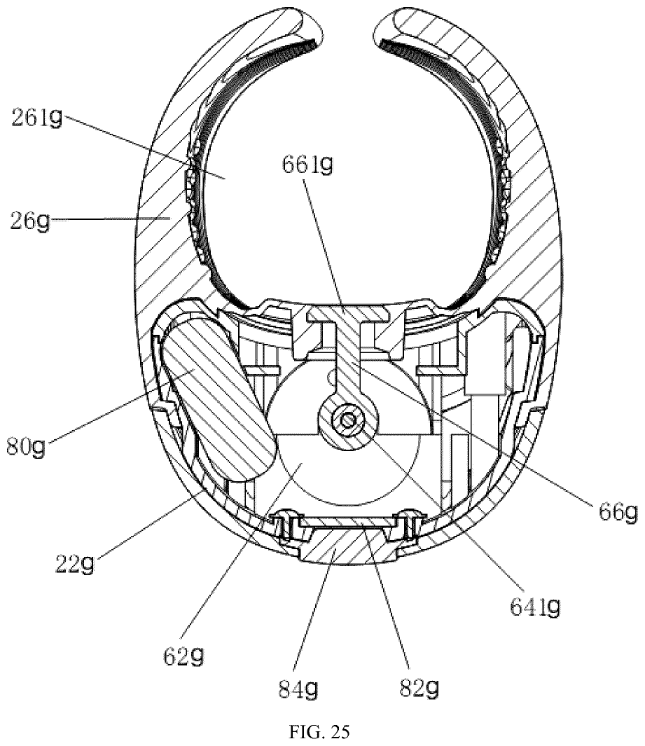

Referring to FIG. 22 to FIG. 27, a sexual massage device 600 according a sixth embodiment of the present application is shown. The sexual massage device 600 includes a shell 20g and a stimulation assembly mounted in the shell 20g.

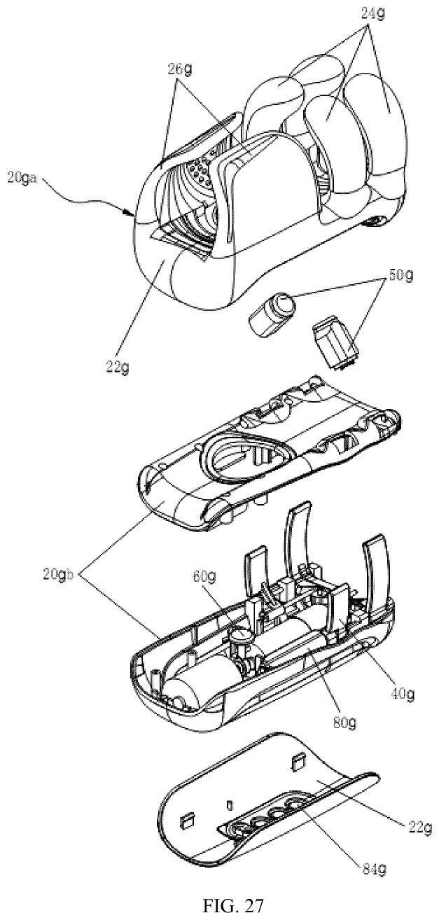

As shown in FIG. 22 and FIG. 27, the shell 20g in whole is configured as a human hand, which includes a main portion 22g configured as a palm and several massage portions 24g extending from two opposite sides of the main portion 22g, respectively. The massage portions 24g each are elongated, curved, and column-shaped, being configured as a finger. Further, two fixed portions 26g extend from two opposite sides of the main portion 22g, respectively. The fixed portions 26g each are configured as a curved sheet, and arranged in a row with the massage portions 24g at a same lateral side of the main portion 22g.

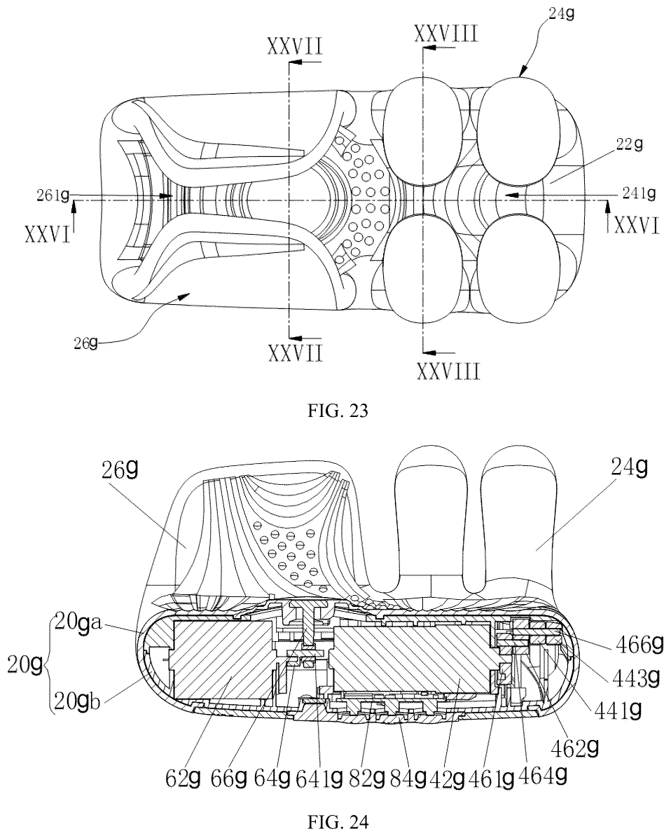

Referring also to FIG. 23, the massage portions 24g of the shell 20g cooperatively define a first inner chamber 241g thereamong. Referring also to FIG. 23, the fixed portions 26g of the shell 20g cooperatively define a second inner chamber 261g therebetween. The first inner chamber 241g and second inner chamber 261g communicate with each other and cooperatively define a stimulation chamber 28g, which is generally column-shaped and configured for receiving a sensitive part of the human body, such as a male genitalia therein.

As shown in FIG. 24 to FIG. 27, the shell 20g is a double-layer structure, and includes an outer shell 20ga and an inner shell 20gb inside the outer shell 20ga. The inner shell 20gb may be made of hard materials, such as plastic, metal and etc., providing support to the stimulation assembly mounted inside the shell 20g; and the outer shell 20ga may be made of soft materials, such as silicone, rubber and etc., for directly contacting the male genitalia, thereby the sexual massage device 600 in whole has high strength and comfortable use experience.

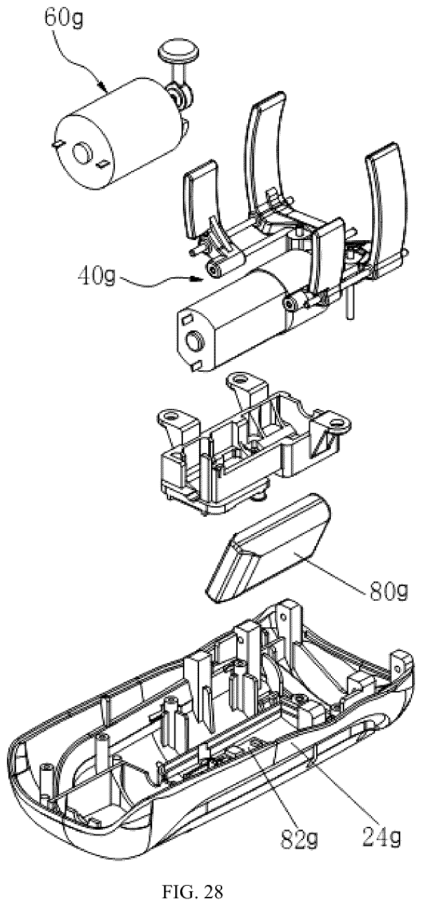

Referring to FIG. 27 and FIG. 28, the stimulation assembly of this embodiment includes a first stimulation module 40g, a second stimulation module 50g and a third stimulation module 60g.

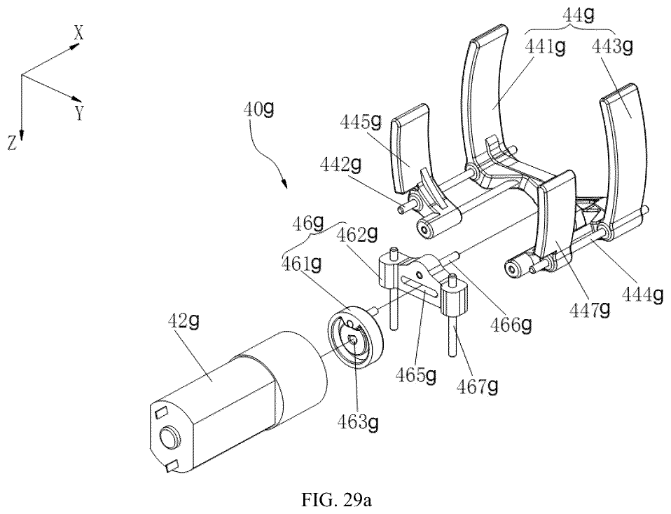

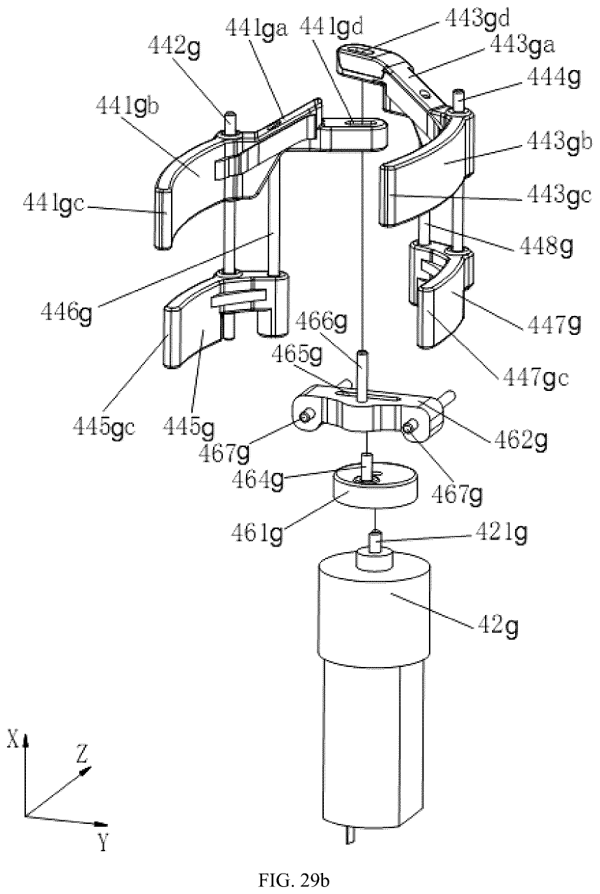

As shown in FIG. 29a and FIG. 29b, the first stimulation module 40g includes a first motor 42g, a swinging unit 44g and a first transmission unit 46g connected between the first motor 42g and the swinging unit 44g. The swinging unit 44g includes a first swinging bar 441g and a second swinging bar 443g which are substantially arranged symmetric to each other. During operation of the first motor 42g, the first swinging bar 441g and second swinging bar 443g are driven to swing relative to the shell 20g, close to or away from each other, thereby achieving an occlusion action to occlude the male genitalia inside the stimulation chamber 28g.

The first swinging bar 441g includes a first connecting arm 441ga and a first swinging arm 441gb which are connected to each other. Preferably, the first connecting arm 441ga and the first swinging arm 441gb are integrally formed as one piece, and an included angle is set therebetween. A joint portion of the first connecting arm 441ga and the first swinging arm 441gb is rotatably connected to the inner shell 20gb by a first pivot 442g. A distal end of the first connecting arm 441ga away from the first swinging arm 441b is connected to the first transmission unit 46g, and a distal end of the first swinging arm 441gb away from the first connecting arm 441ga is configured as a first swinging end 441gc and extends into one of the massage portions 24g at a first lateral side (such as a left side in FIG. 29a) of the shell 20g.

Similarly, the second swinging bar 443g includes a second connecting arm 443ga and a second swinging arm 443gb which are connected to each other and angled with each other. A joint portion of the second connecting arm 443ga and the second swinging arm 443b is rotatably connected to the inner shell 20gb by a second pivot 444g. A distal end of the second connecting arm 443ga away from the second swinging arm 443gb is connected to the first transmission unit 46g, and a distal end of the second swinging arm 443gb away from the second connecting arm 443ga is configured as a second swinging end 443gc and extends into one of the massage portions 24g at a second lateral side (such as a right side in FIG. 29a) of the shell 20g.

The distal ends of the first and second connecting arms 441ga, 443ga can be driven to move along a first direction, such as Z-direction, and thus the first and second swinging arms 441gb, 443gb can swing about the first pivot 442g and second pivot 444g, respectively.

The first pivot 442g and second pivot 444g both extend along a second direction, such as X-direction, being parallel to and spaced from each other. The first swinging end 441gc and the second swinging end 443gc are opposite to each other in a third direction, such as Y-direction. During operation, the first motor 42g drives the distal ends of the first connecting arm 441ga and the second connecting arm 443ga to do reciprocating movement synchronously in the Z-direction through the first transmission unit 46g, making the first swinging bar 441g swing about the first pivot 442g and the second swinging bar 443g swing about the second pivot 444g in opposite directions, thereby the first swinging end 441gc and second swinging end 443gc swinging towards or away from each other to achieve the occlusion action.

In this embodiment, the swinging unit 44g further includes a third swinging bar 445g and a fourth swinging bar 447g which are arranged substantially symmetric to each other. The first pivot 442g extends into a middle portion of the third swinging bar 445g to rotatably connect the third swinging bar 445g to the inner shell 20gb, and the second pivot 444g extends into a middle portion of the fourth swinging bar 447g to rotatably connect the fourth swinging bar 447g to the inner shell 20gb. The first pivot 442g may be fixed to the first and third swinging bars 441g, 445g to rotate along therewith, or, may be fixed to the inner shell 20gb; and the second pivot 444g may be fixed to the second and fourth swinging bars 443g, 447g to rotate along therewith, or, may be fixed to the inner shell 20b.

The third swinging bar 445g has one end configured as a third swinging end 445gc and extending into another one of the massage portions 24g at the first lateral side of the shell 20g, and another end being fixedly connected to the first connecting arm 441ga of the first swinging bar 441g by a third pivot 446g, thereby the third swinging bar 445g can swing about the first pivot 442g together with the first swinging bar 441g; and the fourth swinging bar 447g has one end configured as a fourth swinging end 447gc and extending into another one of the massage portions 24g at the second lateral side of the shell 20g, and another end being fixedly connected to the second connecting arm 443ga of the second swinging bar 443g by a fourth pivot 448g, thereby the fourth swinging bar 447g can swing about the second pivot 444g together with the second swinging bar 443g. The third swinging end 445gc and the fourth swinging end 447gc are opposite to each other in the Y-direction, which can swing towards or away from each other to achieve an occlusion action.

In this embodiment, corresponding to the first to fourth swinging ends 441gc, 443gc, 445gc, 447gc of the first to fourth swinging bars 441g, 443g, 445g, 447g of the swinging unit 44g of the first stimulation module 40g, the shell 20g, specifically the outer shell 20ga, is provided with four massage portions 24g which accommodate the four swinging ends 441gc, 443gc, 445gc, 447gc therein, respectively. During operation, the massage portions 24g swing together with the swinging ends 441gc, 443gc, 445gc, 447gc to occlude the male genitalia in the stimulation chamber 28g. Such sexual massage device can simulate as a human hand to hold and pinch the male genitalia, which can better stimulate users.

It should be understood that a number of the swinging bars of the swinging unit is preferably multiple, such as two, three, four, six, eight, etc., which should not be limited to specific embodiments; and, a number of the massage portions of the shell may be designed the same as that of the swinging bars, thereby accommodating and swinging together with the swinging ends of the swinging bars, respectively.

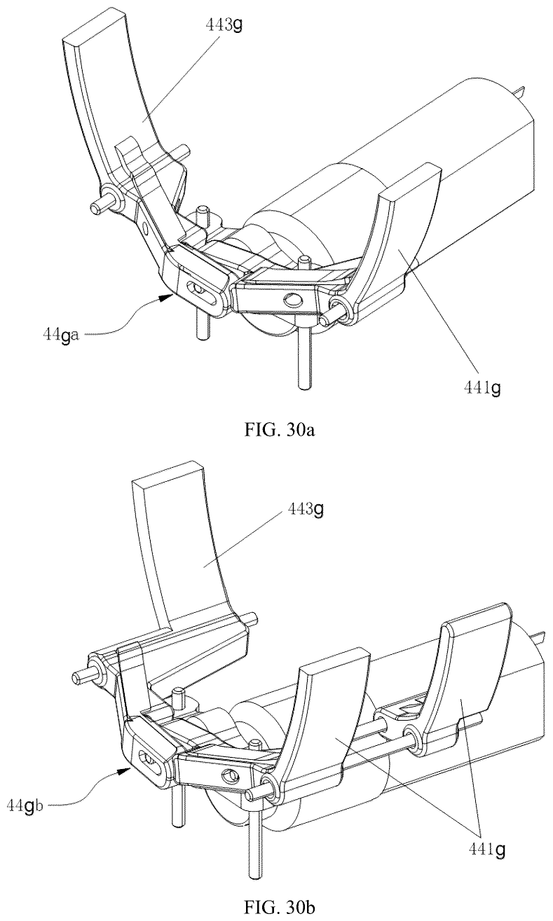

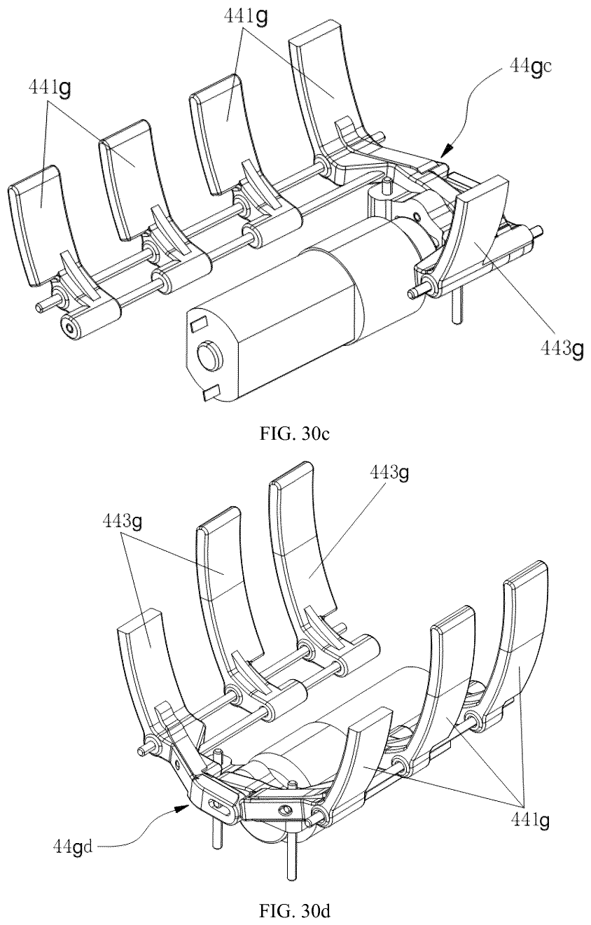

FIG. 30a to FIG. 30d show alternative embodiments of the swinging unit. FIG. 30a shows a swinging unit 44ga with a first swinging bar 441g and a second swinging bar 443g, wherein the two swinging bars 441g, 443g are arranged substantially symmetric to each other in the Y-direction. FIG. 30b shows a swinging unit 44gb with three swinging bars 441g, 443g being staggered in the X-direction, wherein two first swinging bars 441g are located at the same lateral side, and one second swinging bar 443g is located at an opposite lateral side. FIG. 30c shows a swinging unit 44gc with five swinging bars 441g, 443g, wherein four first swinging bars 441g are located at the same lateral side, and one second swinging bar 443g is located at an opposite lateral side. FIG. 30d shows a swinging unit 44gd with six swinging bars 441g, 443g, wherein one lateral side is provided with three first swinging bars 441g and an opposite lateral side is provided with three second swinging bars 443g.

Referring to FIG. 29a and FIG. 29b, in this embodiment, the first motor 42g is a rotary motor, and has a rotary shaft 421g for outputting torque. The first transmission unit 46g is configured for converting rotation of the first motor 42g into reciprocating movement along the first direction, thereby driving the distal ends of the first and second connecting arms 441ga, 443ga to move in the first direction. The first transmission unit 46g includes a first eccentric wheel 461g and a sliding piece 462g.

The first eccentric wheel 461g is connected to the rotary shaft 421g of the first motor 42g. In this embodiment, the first eccentric wheel 461g is generally circular-shaped, and a central hole 463g is defined in a central portion thereof for inserting of the rotary shaft 421g therein. The central hole 463g of the first eccentric wheel 461g is non-circular shaped, such as D-shaped, and a cross section of the rotary shaft 421g has a shape matching with that of the central hole 463g. After inserting of the rotary shaft 421g into the central hole 463g of the first eccentric wheel 461g, a relative rotation therebetween is limited for shape matching, thereby the first eccentric wheel 461g can rotate along with the rotary shaft 421g of the first motor 42g.

A first rod 464g extends outwardly from a periphery of the first eccentric wheel 461g, that is, the first rod 464g is set eccentrically on the first eccentric wheel 461. Generally, the first rod 464 is parallel to the rotary shaft 421g of the first motor 42g. During rotation of the first eccentric wheel 461g along with the rotary shaft 421g of the first motor 42g, the first rod 464g revolves round the rotary shaft 421g. In this embodiment, the rotary shaft 421g extends along the X-direction, and the first rod 464g revolves round the rotary shaft 421g in YZ plane. In other words, the first rod 464g generates displacements on both the Y-direction and the Z-direction under the driving of the first motor 42g.

The sliding piece 462g defines an elongated sliding slot 465g therein, which is strip-shaped and elongated in the Y-direction. The first rod 464g engages into the elongated sliding slot 465g, and is fixed relative to the sliding piece 462g in the Z-direction whilst is slidable relative to the sliding piece 462g in the Y-direction. During revolving of the first rod 464g round the rotary shaft 421g, its displacement in the Y-direction make it slide in the elongated sliding slot 465g and thus cannot drive the sliding piece 462g to move in the Y-direction, while its displacement in the Z-direction drives the sliding piece 462g to do reciprocating movement in the Z-direction. Thereby, rotation of the first motor 42g is converted into reciprocating liner motion of the sliding piece 462g in the Z-direction.

In this embodiment, the distal end of the first connecting arm 441ga defines a first slot 441gd therein, and the distal end of the second connecting arm 443ga defines a second slot 443gd therein. A second rod 466g extends outwardly from the sliding piece 462 along the X-direction, and is movably engaged into the first slot 441gd and the second slot 443d, thereby the sliding piece 462g can drive the distal ends of the first and second connecting arms 441ga, 443ga to do reciprocating movement synchronously in the Z-direction. The first and second slots 441gd, 443gd may be strip-shaped in an extension direction of the first and second connecting arms 441ga, 443ga, thereby the second rod 466g having more movement allowance in the first and second slots 441gd, 443gd.

In this embodiment, the sliding piece 462g is movably connected to the inner shell 20gb by a fifth pivot 467g which extends along the Z-direction. The fifth pivot 467g movably extends into the sliding piece 462g, thereby guiding movement of the sliding piece 462g in the Z-direction. Preferably, each end of the sliding piece 462g in the Y-direction is provided with one fifth pivot 467g, thus a movement of the sliding piece 462g in the Z-direction can be more stable, and accordingly swinging of the swinging ends 441gc, 443gc, 445gc, 447gc of the swinging unit 44g driven by the second rod 466 of the sliding piece 462 can be more consistent and powerful. That is to say, the stimulation intensity of each massage portion 24g of the sexual massage device 600 is more consistent and the overall stimulation effect is better.

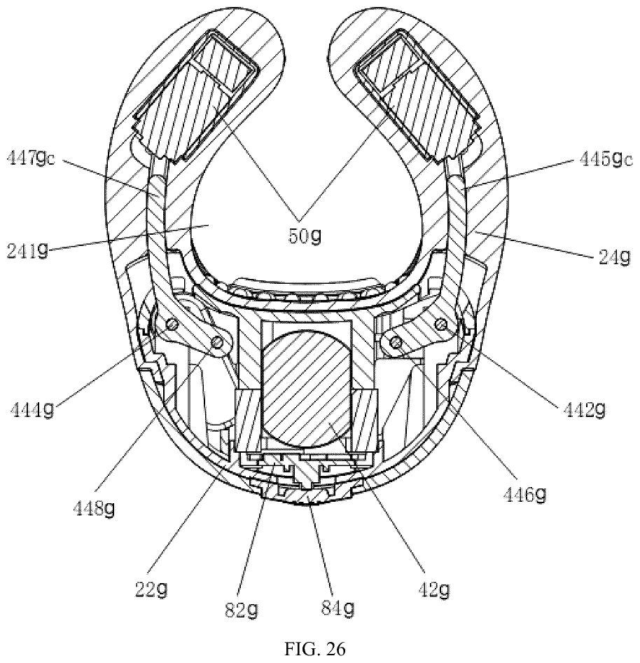

As shown in FIG. 26 and FIG. 27, the second stimulation module 50g further includes at least one vibration member, such as a second motor 52g, preferably a vibration motor. The second motor 52g is set in the massage portions 24g of the shell 20g, and located adjacent to distal ends of the massage portions 24g. The second motor 52g is configured for generating high-frequency vibration to the male genitalia in the stimulation chamber 28g. Preferably, there are several second motors 52g, and each second motor 52g is set in one of the massage portions 24g. During in use, the first stimulation module 40g or the second stimulation module 50g may be started separately, or the first stimulation module 40g and the second stimulation module 50g may be started at the same time.

### Seventh Embodiment

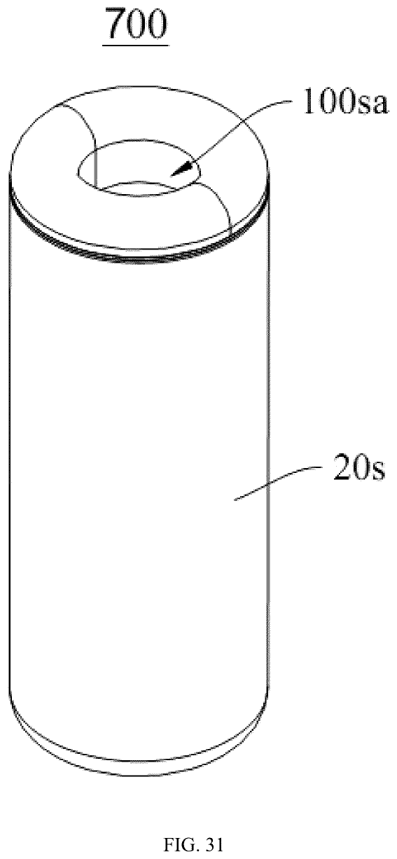

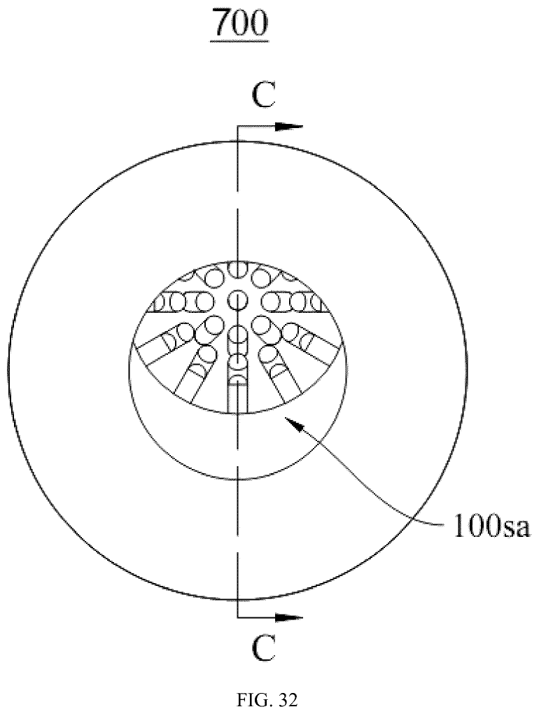

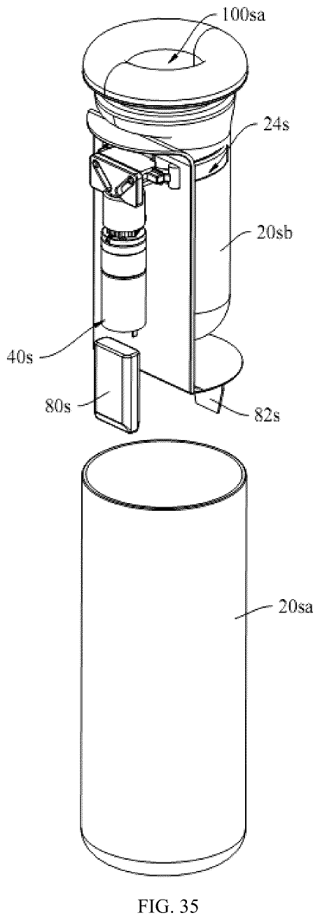

Referring to FIG. 31 to FIG. 36, a sexual massage device 700 according to a seventh embodiment of the present disclosure is shown. The sexual massage device 700 includes a shell 20s including at least two massage portions 24s, and a first stimulation module 40s. The first stimulation module 40s includes a first sliding rod 241s and a second sliding rod 242s respectively arranged on opposite sides and extending into the at least two massage portions 24s of the shell 20s, for driving the first sliding rod 241s and the second sliding rod 242s to slide towards or away from each other.

The shell 20s includes an outer tube 20sa and an inner tube 20sb disposed inside of the outer tube 20sa. The at least two massage portions 24s are defined to be parts of the inner tube 20sb corresponding to the at least two sliding bars 241s, 242s. The inner tube 20sb is hollow and defines a stimulation chamber 100sa therein for receiving a male penis. In this embodiment, the stimulation chamber 100sa is cylindrical. An accommodating chamber 100sb is formed between the outer tube 20sa and the inner tube 20sb. The at least two massage portions 24s are defined to be parts of the inner tube 20sb corresponding to the at least two sliding bars 241s, 242s. In some embodiments, the at least two massage portions 24s may be integrally formed with the inner tube 20sb. In some embodiments, the inner tube 20sb may serve as the massage portions 24s, and the first and second sliding rods 241s, 242s may attach to the inner tube 20sb directly.

Exemplarily, the outer tube 20sa is substantially a hollow cylindrical structure. The inner tube 20sb is entirely made of soft materials, such as silicone. The accommodating chamber 100sb between the outer tube 20sa and the inner tube 20sb is used to place the first, second sliding rods 241s, 242s and etc. The first sliding rod 241s and the second sliding rod 242s are respectively disposed on opposite radial sides of the inner tube 20sb.

Similar to the second embodiment, the first sliding rod 241s and the second sliding rod 242s in the present embodiment can slide towards or away from each other. When the first and second sliding rods 241s, 242s slides towards each other, they press the inner tube 20sb inwardly, so as to narrow the radial size of the stimulation chamber 100sa and pinch the male penis received therein.

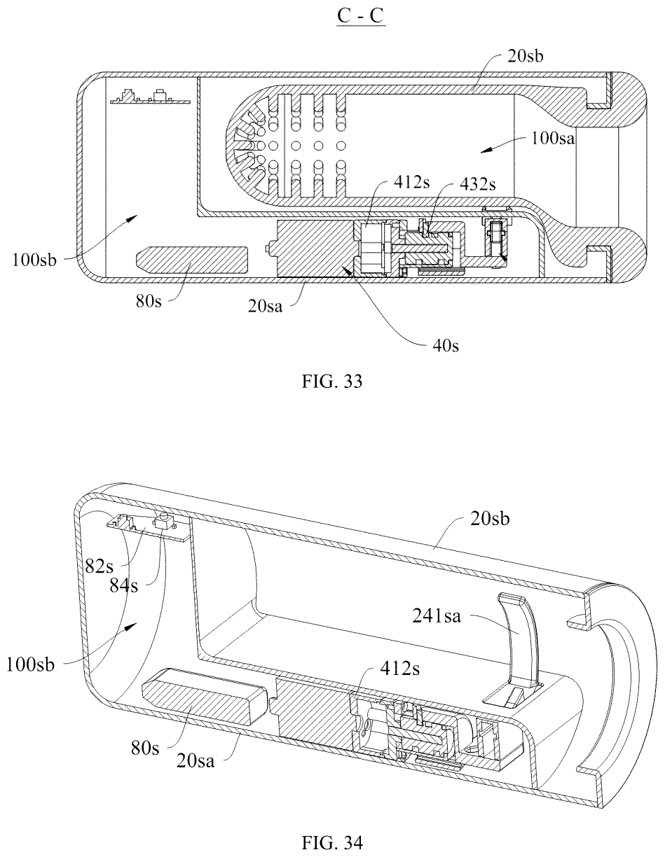

In some embodiments, referring to FIG. 33, one longitudinal or axial end of the inner tube 20sb is open for inserting of the penis therein and the other longitudinal or axial end is closed.

In some embodiments, referring to FIG. 33, the inner tube 20sb is a one-piece component. The integrally molded inner tube 20sb has better integrity, higher sealing, better product consistency and aesthetics, and is beneficial to product sales and user experience.

In some embodiments, the internal structure of the inner tube 20sb is more complex, for example, the inner tube 20sb is configured with inconsistent wall thicknesses, axial bending, and etc. In this case, the inner tube 20sb may be formed by connecting of several ring sections together, which may facilitate the processing and manufacturing of the product, and reduce the cost of the production of the inner tube 20sb.

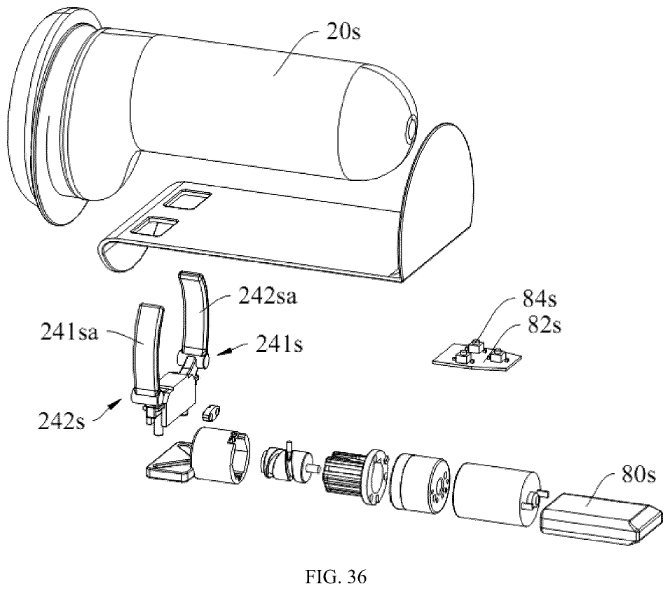

In some embodiments, referring to FIG. 31 and FIG. 36, the sexual massage device 700 further includes a battery 80s and a control circuit board 82s. The control circuit board 82s is electrically connected to the first stimulation module 40s. The battery 80s is electrically connected to both the control circuit board 82s and the first stimulation module 40s, so that the user can perform control operations such as switching ON, switching OFF, and regulating the mode, in particular, the speed of the first stimulation module 40s by means of the control buttons 84s on the control circuit board 82s. The battery 80s is used to supply power to the control circuit board 82s and the first stimulation module 40s. The battery 80s may be a removable battery 80s for easy replacement by the user; the battery 80s may also be a rechargeable battery 80s fixedly disposed within the sexual massage device 700.

In some embodiments, referring to FIG. 31 to FIG. 36, the battery 80s and the control circuit board 82s are received in the accommodating chamber 100sb. The battery 80s is disposed on the side of the first stimulation module 40s away from the massage portions 24s, and the control circuit board 82s is disposed on the longitudinal side of the inner tube 20sb.

### Eighth Embodiment

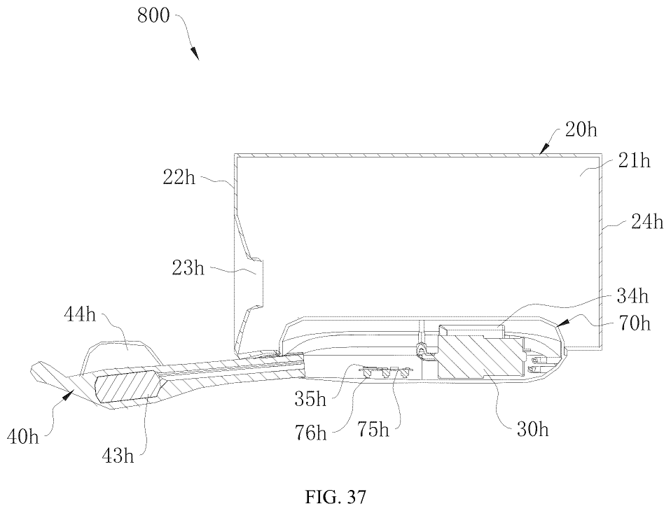

Referring to FIG. 37 to FIG. 42, a sexual massage device 800 according to an eighth embodiment of the present disclosure is shown. Specifically, referring to FIG. 37, the sexual massage device 800 includes: a negative pressure chamber 20h, a negative pressure generating component 30h, and a massage body 40h. The interior of the negative pressure chamber 20h defines a receiving cavity 21h and has a first side end 22h. The receiving cavity 21h extends through the first side end 22h of the negative pressure chamber 20h to form an opening 23h, which is used for allowing a portion of a target part extend into the receiving cavity 21h. The negative pressure generating component 30h is connected to the negative pressure chamber 20h and is used to change the air pressure within the receiving cavity 21h of the negative pressure chamber 20h, thereby regulating the blood flow to the target part subjected to negative pressure. The massage body 40h is located outside the first side end 22h of the negative pressure chamber 20h and is connected to the negative pressure chamber 20h. The massage body 40h is used to massage the other portion of the target part to be massaged, which is adjacent to the part of the body part subjected to negative pressure.

In the sexual massage device 800 of the present invention, the target part extends into the receiving cavity 21h of the negative pressure chamber 20h through the opening 23h. A sealed contact is formed between an edge of the opening 23h and the target part. When the negative pressure generating component 30h adjusts the air pressure in the receiving cavity 21h to a negative pressure, a negative pressure environment is created within the receiving cavity 21h. Since the user's body parts outside the receiving cavity 21h are subjected to higher air pressure, the blood vessels in the target part dilate due to the pressure difference, increasing the blood flow to this part. This results in more oxygen and nutrients being delivered to the target part. Additionally, the massage body 40h exerts a massaging effect on the portion outside the receiving cavity 21h of the target part, effectively increasing the massage area of the sexual massage device 800 and enhancing the user experience.

Specifically, in one application, the portion of the target part inside the receiving cavity 21h may be the penis, and the rest portion of the target part outside the receiving cavity 21h may be the scrotum.

Specifically, the massage body 40h generates a massaging effect on the target part to be massaged through one or more massage manners. The massage body 40h may produce a massaging effect on the target part to be massaged through vibration, oscillation, sliding, clamping, or other forms of motion.

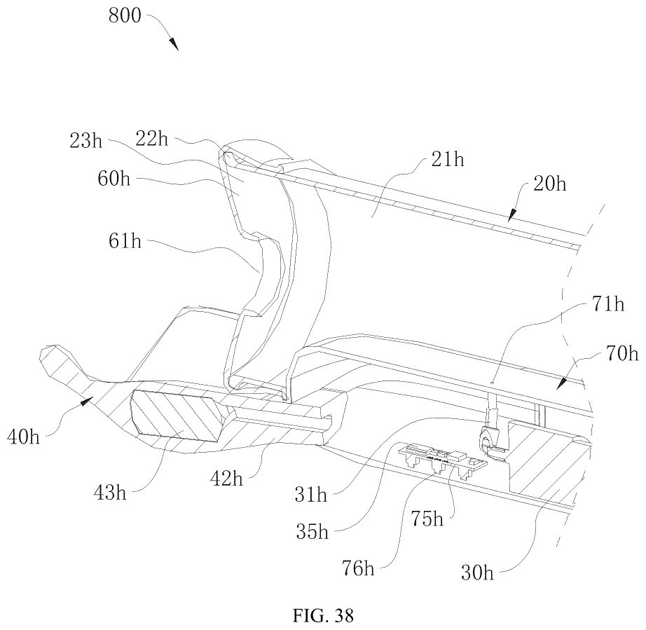

In some embodiments, as shown in FIG. 38, the sexual massage device 800 further includes a vibrator 43h, which is used to transmit vibrations to the massage body 40h. When the target part contacts with the massage body 40h, the massage body 40h may transmit vibrations to the target part, thereby providing a vibrating massage effect.

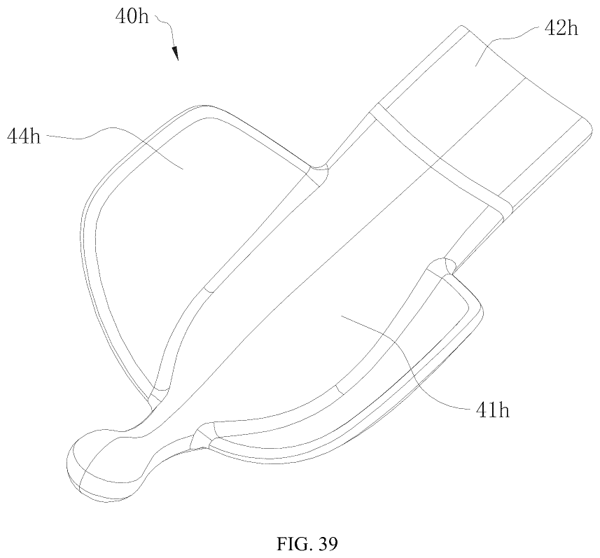

In some embodiments, as shown in FIG. 38 and FIG. 39, the massage body 40h includes a first contact portion 41h and a connecting portion 42h. The first contact portion 41h is located outside the first side end 22h of the negative pressure chamber 20h. Specifically, the first contact portion 41h is configured to contact the target part to produce a massaging effect on the target part. The connecting portion 42h is connected between the negative pressure chamber 20h and the first contact portion 41h, thereby stabilizing the position of the first contact portion 41h relative to the negative pressure chamber 20h. Specifically, the connecting portion 42h is flexible. When the target part is in compressive contact with the first contact portion 41h, the connecting portion 42h is able to deform, thereby limiting the magnitude of the compressive force between the first contact portion 41 and the target part, and avoiding excessive pressure on the target part. Specifically, when the connecting portion 42h has a certain degree of shape stability, the target part can be supported on the first contact portion 41h.

In some embodiments, as shown in FIG. 38, a vibrator 43h may be installed in the first contact portion 41h. Since the first contact portion 41h directly contacts the target part, enhancing the vibration effect in the target part. Specifically, the vibrator 43h is a vibration motor or other devices capable of generating vibrations.

In some embodiments, as shown in FIG. 38 and FIG. 39, the massage body 40h further includes at least one second contact portion 44h connected to the first contact portion 41h. Specifically, since the second contact portion 44h is connected to the first contact portion 41h, it can simultaneously contact the target part, thereby increasing the contact area between the massage body 40h and the target part and allowing the massage body 40h to produce a larger range of massaging effects.

Furthermore, the at least one second contact portion 44h forms a space to accommodate the target part. Specifically, a single second contact portion 44h can be in the shape of a ring or an arc to form a space that can accommodate the target part. Alternatively, at least two second contact portions 44h can be positioned on opposite sides of the first contact portion 41h, forming a space to accommodate the target part between the two second contact portions 44h. More specifically, as shown in FIG. 39, the second contact portion 44h is in the shape of an arcuate sheet.

In some embodiments, the second contact portion 44h is integrally connected to the first contact portion 41h, thereby enhancing the connection stability between the second contact portion 44h and the first contact portion 41h and simplifying the assembly of the massage body 40h.

In some embodiments, the massage body 40h may slide away from or towards the negative pressure chamber 20h under the action of a drive device.

In some embodiments, the negative pressure care device 800 further includes a swing drive mechanism connected to at least two second contact portions 44h. The swing drive mechanism is configured to drive the at least two second contact portions 44h to swing towards or away from each other.

In some other embodiments, the second contact portion 44h may swing away from or towards the negative pressure chamber 20h.

In some embodiments, a vibrator is installed in the at least one second contact portion 44h. Since the second contact portion 44h may directly contact the target part, the path for vibration energy transfer is shortened, enhancing the vibration effect on the target part.

In some embodiments, vibrators are respectively installed in the first contact portion 41h and the second contact portion 44h.

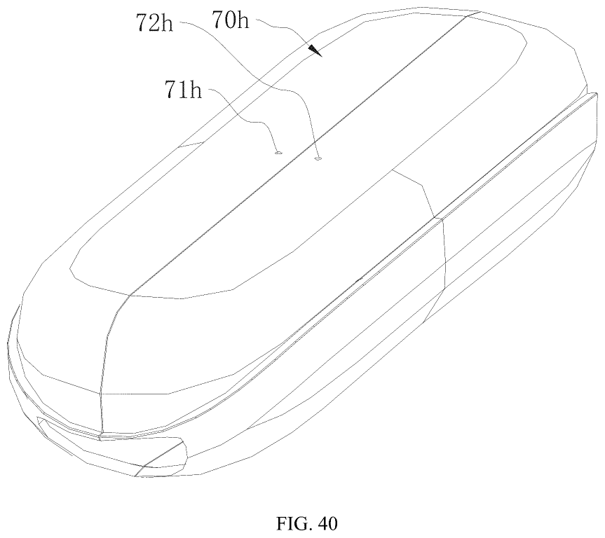

In some embodiments, as shown in FIG. 40 to FIG. 42, the sexual massage device 800 further includes a first pipeline 31h. The negative pressure generating component 30h is connected to the receiving cavity 21h through the first pipeline 31h. Specifically, the negative pressure generating component 30h may be connected to the negative pressure chamber 20h through the first pipeline 31h. More specifically, the negative pressure chamber 20h is provided with a first through-hole 71h, and the receiving cavity 21h is connected to the first pipeline 31h through the first through-hole 71h. When the negative pressure generating component 30h is in operation, gas is extracted from the receiving cavity 21h through the first pipeline 31h and discharges the gas to the outside of the sexual massage device 800 through the first pipeline 31h.

In some embodiments, as shown in FIG. 40 to FIG. 42, the sexual massage device 100 further includes a second pipeline 32h and a valve 33h. The second pipeline 32h is connected to the receiving cavity 21h. The valve 33h is connected in series in the second pipeline 32h and is used to control the opening and closing of the second pipeline 32h. Specifically, the valve 33h has an open state and a closed state. When the sexual massage device 800 is in use, the valve 33h is in the closed state, and the negative pressure generating component 30h extracts gas from the receiving cavity 21h, causing the air pressure in the receiving cavity 21h to gradually decrease. When the use of the sexual massage device 800 is turned off, the negative pressure generating component 30h stops working, and the valve 33h switches to the open state. External gas rapidly flows into the receiving cavity 21h through the second pipeline 32h, allowing the air pressure in the receiving cavity 21h to quickly return to normal, facilitating the withdrawal of the target part from the receiving cavity 21h. Specifically, the valve 33h may be connected to the negative pressure chamber 20h through the second pipeline 32h. The receiving cavity 21h is connected to the second pipeline 32h through a second through-hole 72h.

In some embodiments, the valve 33h is an electromagnetic valve. In alternatively embodiments, the state of the valve 33h is switched manually.

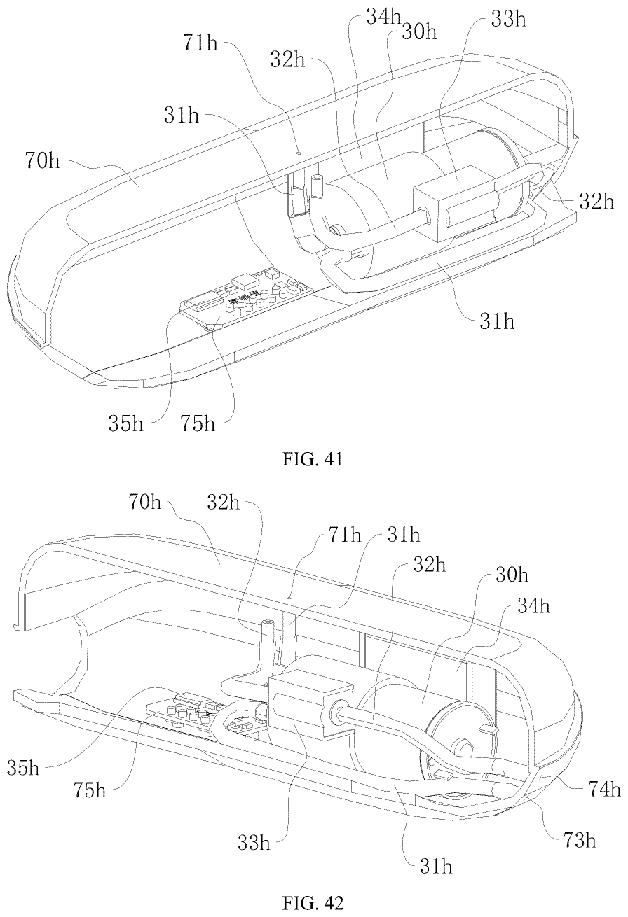

In some embodiments, as shown in FIG. 41 and FIG. 42, the sexual massage device 800 further includes a power component 34h. The negative pressure generating component 30h includes a vacuum pump and a drive source. The drive source is electrically connected to the power component 34h. Specifically, the power component 34h supplies current to the drive source of the negative pressure generating component 30h, causing the airflow mechanism in the vacuum pump to operate, thereby extracting gas from the receiving cavity 21h. Specifically, the negative pressure generating component 30h is an electric vacuum pump.

Specifically, the power component 34h may be a lithium battery, capacitor, or other device capable of providing electrical energy to the drive source. Specifically, the drive source is an electric motor.

In other embodiments, the negative pressure generating component 30h may also be a propeller or a press-type suction pump.

Specifically, the negative pressure generating component 30h has a structure that prevents gas backflow. When the negative pressure generating component 30h stops working, external gas is prevented from flowing back into the receiving cavity 21h through the negative pressure generating component 30h.

In some embodiments, as shown in FIG. 41 and FIG. 42, the sexual massage device 80 further includes a controller 35h and a sensor. The sensor is used to detect the pressure in the receiving cavity 21h, and the controller 35h controls the operation of the vacuum pump based on the detection results from the sensor. Specifically, when the detection result reaches the upper pressure limit, the controller 35h stops the vacuum pump. When the detection result is below the lower pressure limit, the controller 35h starts the vacuum pump, ensuring that the negative pressure in the receiving cavity 21h is automatically maintained within a stable range, avoiding discomfort caused by excessive negative pressure and ensuring the effectiveness of the device. Furthermore, the controller 35h is also used to control the state switching of the valve 33h.

Specifically, the power component 34h supplies current to the vibrator 43h. The vibrator 43h operates under the control of the controller 35h.

In some embodiments, as shown in FIG. 38, the sexual massage device 800 further includes a sealing member 60h that seals the opening 23h. The sealing member 60h and the negative pressure chamber 20 together form the boundary of the receiving cavity 21. The sealing member 60h is flexible and has a central hole 61h for the target part to pass through. Specifically, when the target part passes through the central hole 61h, the edge of the central hole 61h tightly fits around the outer periphery of the target part, ensuring the sealing of the receiving cavity 21h.

In some embodiments, the sexual massage device 800 further includes a base shell 70h connected to the negative pressure chamber 20h. The base shell 70h and the negative pressure chamber 20h together enclose the receiving cavity 21h. The negative pressure generating component 30h is housed within the base shell 70h. Specifically, the base shell 70h provides installation and protection for the negative pressure generating component 30h. At the same time, the base shell 70h and the negative pressure chamber 20h together enclose the receiving cavity 21h, simplifying the structure of the sexual massage device 800.

Furthermore, a portion of the base shell 70h is housed within the negative pressure chamber 20h, allowing the volume of the sexual massage device 800 to be appropriately controlled without affecting the space for accommodating the target part, thereby improving the compactness of the device.

In some embodiments, the vibrator 43h is housed within the base shell 70h, and vibration is transmitted to a first contact portion 41h through a component with a certain degree of rigidity.

Specifically, the connecting portion 42h is connected between the base shell 70h and the first contact portion 41h. Furthermore, the negative pressure chamber 20h has a second side end 24h, and the second side end 24h is disposed opposite to the first side end 22h. The base shell 70h is located between the first side end 22h and the second side end 24h, thereby reducing an extension length of the connecting portion 42h to improve a shape stability of the connecting portion 42h.

In other embodiments, as shown in FIG. 40, the first through-hole 71h and the second through-hole 72h are located on the base shell 70h. Furthermore, the first pipeline 31h can be partially or entirely omitted by directly connecting the port of the negative pressure generating component 30h to the inner wall of the base shell 70h. Similarly, the second pipeline 32h may be partially or entirely omitted by directly connecting the port of the valve 33h to the inner wall of the base shell 70h.

In some embodiments, as shown in FIG. 42, the base shell 70h further has a third through-hole 73h and a fourth through-hole 74. One end of the first pipeline 31h is connected to the outside of the base shell 70h through the third through-hole 73h. One end of the second pipeline 32h is connected to the outside of the base shell 70h through the fourth through-hole 74h.

In some embodiments, as shown in FIGS. 38 and 42, the sexual massage device 800 further includes a control circuit board 75h housed within the base shell 70h. The controller 35h is located on the control circuit board 75h. Furthermore, the control circuit board 75h is equipped with buttons 76h. More specifically, the buttons 76h can be capacitive touch buttons.

In the present application, the above embodiments may be freely combined within the scope of the claims, the above embodiments may be appropriately modified, or parts of the embodiments are omitted.

Additionally, the scope of the present application is not limited to the above content, but is defined by the claims. Therefore, the embodiments described in this specification are illustrative and not restrictive. Any modifications equivalent replacements, improvements, and etc. made within the spirit and principle of the present application should be within the scope of the present application.

What is claimed is:

1. A sexual massage device capable of massaging a penis, the massage device comprising:
a massage body having a cavity to accommodate the penis;
a clamping component configured to repeatedly clamp and release the penis to clamp the penis thus performing a pinching massage on the penis;
an installation portion mounted on the massage body; and
a negative pressure generating component received in the installation portion;
wherein the massage body is able to be in a negative pressure state provided by the negative pressure generating component to apply pressure massage on the penis to massage the penis; the clamping component defines a receiving space to receive the penis.

2. The sexual massage device according to claim 1, wherein the massage body is an elongated body extending in a first direction, the clamping component comprises at least two swing rods, two swing rods of the at least two swing rods are opposite to each other to define the receiving space and are arranged in a first plane, and the first plane is perpendicular to the first direction.

3. The sexual massage device according to claim 1, wherein the negative pressure generating component is connected to the massage body, an interior of the massage body generates negative pressure under the action of the negative pressure generating component, thereby applying pressure massage to the penis;
the installation portion is sealed on the massage body,
the installation portion has an exhaust hole communicated with external environment, a suction hole communicated with the cavity of the massage body is defined in a top surface of the installation portion;
the negative pressure generating component comprises a negative pressure generating portion, the negative pressure generating portion comprises a suction device, a first connecting pipe, and a second connecting pipe, the suction device is fixed at the end of the massage body, one end of the first connecting pipe is connected to the suction device, and the other end of the first connecting pipe is connected to the suction hole of the installation portion, one end of the second connecting pipe is connected to the suction device, and the other end of the second connecting pipe is connected to the exhaust hole at the end;
when the suction device is started, the suction device sucks the gas in the cavity through the first connecting pipe, thus creating a negative pressure state in the cavity, the gas sucked by the suction device is discharged to the outside of the massage body through the second connecting pipe.

4. The sexual massage device according to claim 1, wherein the negative pressure generating component comprises an air supply portion, the air supply portion is connected the cavity of the massage body and an outside of the massage body to allow external air to enter the cavity, thereby making the cavity to a non-negative pressure state.

5. The sexual massage device according to claim 4, wherein
the installation portion is sealed on the massage body, an air intake hole and an air supply hole are defined in the installation portion, the air supply hole is communicated with the cavity, and the air intake hole is communicated with the outside of the massage body;
the air supply portion comprises an electromagnetic valve, a first air delivery pipe, and a second air delivery pipe, one end of the first air delivery pipe is connected to the electromagnetic valve, and the other end of the first air delivery pipe is connected to the air supply hole, one end of the second air delivery pipe is connected to the electromagnetic valve, and the other end the second air delivery pipe is connected to the air intake hole.

6. The sexual massage device according to claim 1, wherein
the clamping component comprises at least two swing rods or at least two sliders moving towards each other;
the at least two swing rods are partially located inside the massage body or adjacent to an opening of the massage body, and the at least two swing rods are movable closer or apart from each other;
the at least two sliders are located on two opposite sides of the cavity, and are movable closer or apart from each other.

7. The sexual massage device according to claim 6, wherein the sexual massage device comprises a protective cover, the protective cover is covered on the swing rod, and the protective cover is made of soft material.

8. The sexual massage device according to claim 6, wherein
the at least two swing rods extend curvedly from one side of the installation portion, the receiving space is defined between the inner walls of the at least two swing rods, and the receiving space is communicated with the opening;
after the penis enters into the receiving space, the inner walls of the at least two swing rods directly contact the penis.

9. The sexual massage device according to claim 8, wherein
an installation portion is sealed on the massage body,
the clamping component comprises a driving motor, a rotating member, a transmission member, and the two swing rods,
the driving motor is fixed on the installation portion,
the rotating member is connected to an output shaft of the driving motor and the transmission member,
a side of the transmission member away from the rotating member is connected to the two swing rods,
the rotating member driven by the driving motor drives the transmission member, the transmission member drives the two swing rods to swing back and forth in the cavity, thus moving closer or apart from each other.

10. The sexual massage device according to claim 9, wherein an eccentric post is formed on an end face of the rotating member, the transmission member has a transmission shaft on the side away from the rotating member, an elongated moving hole is defined in the middle of the transmission member along a length direction of the transmission member to allow the eccentric post of the rotating member to pass through, two ends of main body of the transmission member further form guiding shafts perpendicularly passing through the transmission member, two ends of the guiding shafts are fixed on installation portion, and two ends of the transmission member are movably installed on the guiding shafts, allowing the transmission member to slide up and down along the guiding shafts.

11. The sexual massage device according to claim 10, wherein the swing rod comprises a swing arm and a connecting arm integrally formed, a lower end of the connecting arm is overlapped and installed on the transmission shaft, the swing arm is bent and extended upward from an upper end of the connecting arm, an elongated sliding slot is defined in an end of the connecting arm away from the swing arm, the transmission shaft is inserted into the sliding slot, and a connecting part for connecting the connecting arm and swing arm is connected to the installation portion via a pivot shaft, allowing the entire swing rod to rotate around the pivot shaft.

12. The sexual massage device according to claim 2, wherein
the installation portion is sealed on the massage body,
the installation portion comprises a first installation portion, a connecting portion, and a second installation portion are sequentially communicated with each other, the first installation portion and the second installation portion are located at two ends of the connecting portion respectively,
the clamping component is installed in the first installation portion,
the negative pressure generating portion is installed in the second installation portion.

13. The sexual massage device according to claim 12, wherein the first installation portion is disposed at one side of the massage body, the second installation portion is disposed at a bottom of the massage body, and the installation portion is generally L-shaped.

14. The sexual massage device according to claim 3, wherein the installation portion is disposed at one side of the massage body, the clamping component and the negative pressure generating portion are installed in the installation portion, and the clamping component and the negative pressure generating portion are at the same side of the massage body; or
the installation portion of the sexual massage device is generally cylindrical and is disposed on a position of the massage body adjacent to the rolled edge structure in a manner generally perpendicular to the massage body.

15. The sexual massage device according to claim 8, wherein the clamping component of the sexual massage device comprises a driving motor, an output shaft, a fixing ring, two fixing posts and two swing rods left-right disposed, the driving motor is a telescopic motor, and an output shaft of the driving motor is capable of moving along a direction away from or towards a motor body, a groove is define in one side wall of the output shaft, the fixing ring is generally a hollow ring, and the fixing ring has a continuous arc on an outer wall thereof and a hexagonal inner wall, a protrusion corresponding to the groove is formed on the inner wall for slidably engaged with the groove, the two fixing posts protrude outward from opposite positions on the outer wall of the fixing ring, the two swing rods each comprises a swing arm and a connecting arm, a generally arc-shaped installation arm is formed on a lower end of each connecting arm, the installation arm extends along the outer wall of the fixing ring, a receiving slot is defined in the installation arm along a length direction of the installation arm, the two installation arms face each other, so that the two fixing posts are received in the receiving slots respectively.

16. The sexual massage device according to claim 6, wherein the at least two swing rods comprises two pairs of parallel swing rods to form a swing assembly, the clamping component is installed outside the installation portion, and the two pair of swing rod are spaced apart from each other.

17. The sexual massage device according to claim 12, wherein the installation portion is installed on an outside wall at one side of the massage body, the installation portion is sealed at a through-hole on one side of the massage body, the installation portion comprises a base cover and a top cover, the base cover is attached to the outside wall of the massage body, and the top cover is engaged with the base cover to form an installation space, and the base cover and the top cover are transparent shells.

18. The sexual massage device according to claim 8, wherein an opening is defined in one side of the installation portion, wherein a sealing member is installed at the opening, or the opening is defined with a rolled edge structure flipped outward along a circumferential direction.

19. A sexual massage device capable of massaging a penis, the sexual massage device comprising:
a massage body having a cavity to accommodate the penis; and
a clamping component installed in the massage body and capable of repeatedly clamping and releasing the penis, the clamping component comprises at least two swing rods, the at least two swing rods are partially located inside the massage body or adjacent to an opening of the massage body, and the at least two swing rods are movable closer or apart from each other to stimulate the penis accommodated inside the cavity during use; or the clamping component comprises at least two sliders moving towards each other, the two sliders are located on two opposite sides of the cavity, and are movable closer or apart from each other to stimulate the penis accommodated inside the cavity during use;
wherein the massage body is able to be in a negative pressure state to apply pressure massage on the penis, and the clamping component is able to perform a pinching massage on the penis.

20. The sexual massage device according to claim 19, wherein the sexual massage device comprises a negative pressure generating component connected to the massage body, an interior of the massage body generates negative pressure under the action of the negative pressure generating component, thereby applying pressure massage to the penis; the negative pressure generating component comprises an air supply portion, the air supply portion is connected the cavity of the massage body and an outside of the massage body to allow external air to enter the cavity, thereby making the cavity to a non-negative pressure state.
